(19) United States
(12) Patent Application Publication
(10) Pub. No.: US 2007/0123354 A1
(43) Pub. Date: May 31, 2007

(54) Gaming machine with security function

(75) Inventor: Kazuo Okada, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE GAMING AMERICA, INC.

(21) Appl. No.: 11/288,143

(22) Filed: Nov. 29, 2005

(51) Int. Cl. G06F 19/00

(52) U.S. Cl. 463/47

(57) ABSTRACT

An object of the present invention is to provide a game machine which prevents a card from being left behind and prevents the player's sense of enjoyment from diminishing by preventing theft due to the card being left behind. The game machine reads individual data of a player from a card inserted into the card reception part (A721) and executes a game program, in addition to the game input data input from the input, gives notification by the notification when the card is detected and that the player is not seated in the seat is detected.

### FIELD OF THE INVENTION

The present invention relates to a game machine.

### RELATED ART

In a first aspect of the background art, conventionally, in game machines for commercial use, not only game machines which perform games separately, but also those commonly referred to as multi-player game machines, are known. In recent years, there has been a horse-racing game machine as such a multi-player game machine. A multi-player game machine such as this includes, for example, a main game machine body to which a large main display part is provided and a plurality of terminal devices to which sub-display parts which are attached to the main game machine body are provided (for example, see Patent Reference 1).

In this multi-player game machine, race horses and the odds thereof are shown in the main display part and the sub display part Each player selects an arbitrary race horse from the race horses shown and bets with medals. Subsequently, a horse race is performed by these race horses in the main display part, and according to the results, each player is paid medals based on the predetermined odds.

In addition, the gaming history of the player can be stored in a memory device, such as a card. Furthermore, continuous playing is made possible through enjoyment of a training process, by training race horses and jockeys during the game and storing the data thereof in a card, and therefore, a new form of enjoyment is provided.

Furthermore, the card can be used as a prepaid card by purchasing gaming rights by paying a predetermined amount of money and storing this as credit. This is not limited to multi-player games and applies to ordinary game machines as well.

Patent Reference 1: Japanese Potent Application Laid-Open Publication Heisei 10-314450

In a second aspect of the background art, conventionally, multi-player-type game machines for commercial use, in which numerous players participate, commonly referred to as multi-player game machines, are known. There has been, for example, a horse-racing game machine as such a multi-player game machine. A multiple player game machine such as this includes a main game machine body to which a large main display part is provided and a plurality of terminal devices to which sub-display parts are provided.

These plural terminal devices include seats, respectively, which seat the players and face the main display part. In this terminal device, each player sits in the seat and performs various operations while viewing the sub-display part.

In this multi-player game machine, race horses and the odds thereof are shown in the main display part and the sub display part. Each player selects an arbitrary race horse from the race horses shown and bets with medals. Subsequently, a horse race is performed by these race horses in the main display part, and according to the results, each player is paid medals based on the predetermined odds.

In a multi-player-game machine such as this, a realistic feeling of being at the racetracks can be enjoyed by listening to the sounds output from a speaker while viewing a video shown in the main display part.

In addition, as a multi-player game, there is an integrated gaming system which includes a cockpit for seating a plurality of players within a theater which is provided with a large screen (refer to Patent Reference 1).

In this integrated game system, a personal computer device provided in each cock pit is connected to an integrated computer device for gaming, and these devices operate together to run a game. Thus, a realistic feeling and tension which cannot be attained through a privately-owned game machine is provided by generating loud sounds and vibrating sensations among the players within the theater.

Patent Reference 2: Japanese Patent Application Laid-Open Publication Heisei 10-314450

In a third aspect of the background art, conventionally, a game hall includes a large number of various game machines called arcade games. These game machines are activated (enters a state enabling a game to be played) when a customer inserts a coin, such as a hundred yen coin, an original game hall medal or the like into respective game machines. Therefore, in each game machine, a large amount of medals, such as coins and the like, were thrown into medal boxes placed within each game machine and stored.

Incidentally, in recent years, the reduction in the cost of liquid crystal display devices has continued, and liquid crystal display devices are starting to be used widely in place of CRT (tube) display devices, even in game machines such as this, for the monitor part of the main game machine body. This is because liquid crystal display devices are advantageous in that they are more power-saving compared to the CRT display devices, capable of providing flat images, and space-saving.

However, because a liquid crystal display device such as this is structured to enclose a special liquid between two glass plates, change the direction of the liquid crystal molecules by applying electrical pressure, and display an image by increasing and reducing the transmission of light, it was softer and more fragile than the conventional CRT display device.

Therefore, when a conventional CRT display device is replaced with a liquid crystal display device, if a medal box is provided within the main game machine body and the main game machine body and the monitor part are formed integrally, as in the game machine implementing the CRT display device, there is a risk that the medal from within the medal box will be stolen from the monitor part by breaking the monitor part in the main game body. Thus, there was a problem in that, in order to replace the CRT display screen of a conventional game machine directly with a flat display, such as a liquid crystal device, security on the display device had to be tightened.

In response, a technology for reinforcing the monitor surface by using a protective cover glass which is not easily broken, such has reinforcing glass, on the monitor surface of a liquid crystal display device has been disclosed (for example, refer to Patent Reference 1). This is a technology in which the liquid crystal film of the liquid crystal display is sandwiched between a pair of glass plates.

Patent Reference 3: Japanese Patent Application Laid-Open Publication Heisei 08-33759

### SUMMARY OF THE INVENTION

However, if a game is played using a card, as in the first aspect of the background art, instances in which the player forgets the card and leaves his seat after the game occur often. In this case, there is risk the forgotten card will be misused by another person, and a problem occurs in that the stored credit is used. In addition, there was also a problem in that the process for re-issuing the card is troublesome and costly, Furthermore, when the card is not re-issued, the game and credits stored in the card are lost, and instances in which the player's sense of enjoyment diminishes significantly and the player gives up on continuing the game also occur.

Furthermore, the card insertion slot is often provided in a device which is separate from the terminal device. Because it is sometimes in a location which is difficult to see when the player is seated in the seat, the possibility of the card being forgotten increases.

In light of the foregoing issues, an object of the present invention is to provide a game machine which prevents a card from being left behind and prevents the player's sense of enjoyment from diminishing by preventing theft due to the card being left behind.

The present invention provides a game machine such as that below, in order to overcome the foregoing problems.

In a first aspect of the present invention, a game machine includes: a game controller (for example, an input operation part A72, described hereafter) for receiving input from a player; a monitor (for example, a main display device A22 and a sub-display part A61, described hereafter) for receiving externally or generating internally and showing a game screen, generated according to a game program; a control (for example, a CPU 81, described hereafter) for executing a game program; a seat (for example, a seat A31, described hereafter) for seating the player; and a card reception part (for example, a card slot A712, described hereafter) for receiving a card for playing a game; in which the seat part includes a seating detection (for example, seating sensors, not shown, which are embedded in a seating part A52 and a back rest A53, described hereafter) for detecting that a player is seated; and a notification (for example, speakers A75, lamps A76, and an input and output part A94) for performing notification when a seated player is not detected and a card is inserted into the card reception part.

According to the first aspect of the invention, the game machine has a notification for performing notification when the seating detection does not detect seating and a card is inserted into the card reception part.

In this way, because notification is given if a card is in the card reception part regardless of the player leaving the seat, it is possible to prevent a card from being left behind. In addition, a game machine which can enable the player's sense of enjoyment to continue by preventing the card from being left behind can be provided.

In a second aspect of the present invention, the game machine according to the first aspect of the invention has a card which includes a memory for storing credit data to which subtraction processing is performed when the game program is executed, and a control which executes the game program by performing subtraction processing on the credit data read by the card reception part included in the seat part.

According to the second aspect of the invention, in addition to the first aspect, a game is started by performing a subtraction processing on the credit data when starting the execution of a game program, by storing credit data in a memory included within the card.

In this way, the card is given monetary value and the importance of the card to the player increases, thus, encouraging players to keep the card in mind so as to eliminate cards being left behind.

In a third aspect of the present invention, a game machine includes: a main game machine body (for example, a main game machine body A20) which includes a memory (for example, a database A84, described hereafter) for storing a game program and a main control (for example, a CPU 81, described hereafter) for executing the game program stored in the memory; a plurality of terminal devices (for example, a terminal device A30, described hereafter) which includes an input (for example, an input operation part A72, described hereafter) for receiving input from a player, and a sub-control (for example, a CPU A91 described hereafter), connected to the main game machine body through wireless connection, for transmitting game input data according to input from the input part to the main game machine body; a display (for example, a main display device A22 and a sub-display part A61, described hereafter) for showing image based on image data output from the main control; in which the main control receives a plurality of game input data from a plurality of terminal devices, generates a single game data according to the game program based on this plurality of game input data, and generates and outputs to the display part image data which is shared by all terminal devices based on this single game data; the terminal device includes a seat part (for example, a seat A31, described hereafter) for enabling the player to be seated; the seat part includes a card reception part (for example, a card slot A712, described hereafter) to which a card storing individual data of a player is inserted, for reading the individual data, and a seat detection part (for example, seating sensors, not shown, which are embedded in a seating part A52 and a back rest A53, described hereafter) for detecting that a player is seated; the card reception part includes a card detection part (for example, a card sensor A723) for detecting that a card is inserted into the card reception part; the sub-control executes the game program based on the individual data read from the card reception part and/or game input data received by the input; and the sub-control includes a notification (for example, speakers A75, lamps A76, and an input and output part A94) for giving notification when the card detection part detects the card and the seating detection part does not detect seating.

According to the third aspect of the invention, in a game machine which includes a main game machine body and a plurality of terminal devices which are connected by wireless connection, the game machine which reads individual data of a player from a card inserted into the card reception part and executes a game program, in addition to the game input data input from the input, gives notification by the notification when the card is detected and that the player is not seated in the seat is detected.

In this way, because the game machine gives notification when the card is in the card reception part regardless of the player having left the seat, the game, cards being left forgotten can be prevented. Furthermore, because individual data and credit information of the player regarding the game are stored, the game can be continued using this individual data. In addition, it is also possible, in some instances, to enable a player's enjoyment to continue by preventing the card from being left behind, such as this.

In a fourth aspect of the present invention, the game machine according to the third aspect of the invention has a card which includes a memory for storing credit data to which subtraction processing is performed when the execution of the game program starts, in which the sub-control executes the game program by performing subtraction processing on the credit data read by the card reception part.

According to the fourth aspect of the invention, in addition to the third aspect, the game machine starts the game by performing subtraction processing on the credit data when the execution of the game program starts, by storing the credit data in the memory included in the card.

In this way, the card is given so-called monetary value and the importance of the card to the player increases, thus, encouraging players to keep the card in mind so as to eliminate cards being left behind.

In a fifth aspect of the present invention, the game machine according to the third or fourth aspect of the invention has: a sub-control which includes a time measurement (for example, a time measurement part A98, described hereafter) for measuring time; a notification which further includes a lamp part (for example, lamps A76, described hereafter) for emitting light, a sound (ex, voice) output part (for example, an input and output part A94 and speaker A75, described hereafter) for performing notification by sound, and a sub-display part (for example, a sub-display part A61, described hereafter) for showing image data generated by the sub-control; in which, when the seating detection part does not detect seating and the card detection part detects the card, the sub-control transmits a first notification start signal, the sub-display part shows at least one part of the data read by the card reception part in response to receiving the first notification start signal, the time measurement measures the time from the first notification start signal, and after a predetermined amount of time passes, if the seating detection does not detect seating and the card detection part detects the card, the sub-control transmits a second notification start signal, the lamp part is illuminated in response to receiving the second notification start signal, and the sound output parts gives second notification by sound in response to receiving the second notification start signal.

According to the fifth aspect of the invention, in addition to the third or fourth aspect, the game machine has a lamp part, a sound output part, and a sub-display part as the notification, gives notification by displaying at least one part of the information in the card in the sub-display part and through sound as the first notification, and if the card is still detected thereafter, gives notification by light from the lamp and sound as the second notification.

In this way, notification can be given in two stages such as, for example, the player is. alerted of the card being left behind by the first notification, and if the card is still detected, other people are also notified by sound and lights. Then, the possibility of the card being left behind can be reduced.

In a sixth aspect of the present invention, the game machine according to the fifth aspect of the invention has a sub-display part which includes a support part (for example, a support arm A661 and A612, described hereafter), fixed at one end to the seat part and connected at the other end to the sub-display part, for supporting the sub-display part to enable positional changes, and a fixation driving mechanism (for example, a connection part A615 and A616 and a display part fixation driving control device A63, described hereafter) for fixing the sub-display part with the support part so as to face the player in a state enabling viewing; in which the sub-control transmits a sub-display fixation release signal to the fixation driving mechanism if the card detection part does not detect the card on the card reception part, and the fixation driving mechanism releases the sub-display fixation part.

According to the sixth aspect of the present invention, in addition to the fifth aspect, the sub-display part is fixed by the fixation driving mechanism by the reception of the sub-display fixation signal, and the fixation of the sub-display part is released by receiving the sub-display fixation release signal.

In this way, because the display part is fixed when the player attempts to leave the seat without removing the card when the game is completed, it can be made so that the player cannot leave the seat because the display part is in the way. The player can be prevented from forgetting to remove the card because there are instances in which the player can realize he has forgotten his card, in this way.

In a seventh aspect of the present invention, a game machine according to the sixth aspect of the invention has a card reception part which further includes a card holding part (for example, a card holding part A724, described hereafter) for holding the card and a card transfer part (for example, a card transfer device A725, described hereafter) for transferring the card to the card holding part; in which the time measurement measures the amount of time from the second notification, and the card transfer part transfers the card to the card holding part, when the time measured by the time measurement reaches a predetermined amount of time and the card detection part detects the card.

According to the seventh aspect of the invention, in addition to the sixth aspect, the card transfer part holds the card in the card holding part if the card is detected even after the time measured by the time measurement part passes a predetermined amount of time.

In this way, if the player leaves behind the card, regardless of the notifications, the card can be held in the card holding part after a predetermined amount of time has passed. Thus, the possibility of the card being stolen by another person can be reduced because the card is held in the card holding part even if it is left behind.

In an eighth aspect of the present invention, the game machine according to the seventh aspect of the invention has a card holding part which includes a holding detection part (for example, a card holding sensor, described hereafter) for detecting that the card transfer part has transferred the card to the card holding part and transmitting a holding completion signal, in which the sub- control gives notification through the notification in response to receiving the holding completion signal.

According to the eighth aspect of the present invention, in addition to the seventh aspect, the notification gives notice when the card transfer part has stored the card in the card holding part.

In this way, because notification can be given when the card is held in the card holding part, it can be made clear which terminal device is holding the card if, for example, there is a plurality of terminal devices, Therefore, for example, arcade staff or the like can collect the card without searching when collecting the card. In addition, by giving notification, the staff can be encouraged to collect the card and the possibility of the card being left in the card holding part for a long period of time can be reduced, thus, reducing the possibility of theft even further.

In a ninth aspect of the present invention, the game machine according to the fifth aspect of the invention has a card reception part which further includes a card holding part for holding the card and a card transfer part for transferring the card to the card holding part; in which the time measurement measures the amount of time from the second notification, and the card transfer part transfers the card to the card holding part, when the time measured by the time measurement reaches a predetermined amount of time and the card detection part detects the card.

In a tenth aspect of the present invention, the gaming machine according to the ninth aspect of the invention has a card holding part which includes a holding detection part for detecting that the card transfer part has transferred the card to the card holding part and transmitting a holding completion signal, in which the sub-control gives notification through the notification in response to receiving the holding completion signal.

According to the first aspect of the present invention, the game machine prevents the card from being left behind and prevents the player's sense of enjoyment from diminishing by preventing theft due to the card being left behind.

In a terminal device of a multi-player game machine such as that according to the second aspect of the background art, in most instances, there is no space for the player to place his belongings when playing a game. Thus, in most cases, the player had no choice but to place his belongings at his feet or near the seat. In addition, although there are instances in which a hook for hanging belongings or a bag for holding belongings is provided within the terminal device, the hooks and the like cannot be locked to fix the belongings. Therefore, this sometimes causes a reduction in the player's sense of enjoyment because the player cannot concentrate on the game due to fear that his belongings will be stolen while he is playing a game.

In addition, if a wall is placed around the seat of the terminal device, like a shelter, for the effect of playing the game in a private room, in most cases, sufficient space is not provided for placing belongings. Then, the player must play the game while fearing theft because his belongings get in the way it is placed at his feet and are, thus, placed where the player cannot see during the game. Therefore, instances occur in which the player's sense of enjoyment diminishes.

Furthermore, if belongings are stored in a locker or the like beforehand, the player must keep the locker key. Because the locker key is often small, the player often loses the key while concentrating on the game or cannot concentrate on the game because he is worried about the key.

In light of the foregoing issues, an object of the present invention is to provide a terminal device of a game machine which can enable the player to concentrate on the game at ease by preventing the theft of belongings and can enhance the sense of enjoyment of each player.

The present invention provides a terminal device such as that below, in order to overcome the foregoing problems.

In an eleventh aspect of the present invention, a game machine includes: a game controller (for example, an input operation part B72, described hereafter) for receiving input from a player; a display part (for example, a main display device B22 and a sub-display part B51, described hereafter) for receiving externally or generating internally and showing a game image, generated according to a game program; a seat (for example, a seat B31, described hereafter) for seating the player; and a control (for example, a main control device, described hereafter) for executing a game program; and a lock (for example, a hook B40, described hereafter) which has an anti-theft mechanism for hanging or holding the player's belongings, which is normally in an unlocked state and enters a locked state in response to the start of a game.

According to the eleventh aspect of the present invention, the lock which is normally in an unlocked state can enter a locked state when the control receives a game start signal and can enter an unlocked state when a game completion signal is received. In this way, because a key or the like for locking is not required, the player can concentrate on the game without thinking about the whereabouts of the key or theft of his belongings and the player's sense of enjoyment can be enhanced.

In a twelfth aspect of the present invention, the game machine according to the eleventh aspect of the invention has: a lock which includes a U-shaped hook part (for example, a hook B40, described hereafter) having an upper aperture and connected to the seat part, a stopper (for example, a stopper B413, described hereafter) for closing the upper aperture and preventing the object-to-be-hung hooked to the hook part from being removed, a lock control part (for example, a hook control device B412, described hereafter) for switch-controlling the upper aperture to both closed and open state by engaging the stopper to the upper aperture or releasing the engagement, and a load detection part (for example, a sensor B415, described hereafter) for detecting that an object-to-be-hung is hung on the hook part; in which the lock control part changes the upper aperture from an open-state to a closed-state by the stopper, in response to the load detection part detecting that a object-to-be-hung is hung on the hook part and a predetermined excessive load is applied.

According to the twelfth aspect of the present invention, when a hook for hanging belongings is provided and the player hangs his belongings on the hook, the load detection can detect this and place the stopper in a closed-state. In this way, the risk of theft of belongings during a game can be reduced. In addition, because this operation is performed automatically and a key for locking is not necessary, the player can concentrate on the game without thinking about the whereabouts of the key or theft of his belongings and the player's sense of enjoyment can be enhanced.

In a thirteenth aspect of the present invention, the game machine according to the eleventh aspect has; a lock which includes a U-shaped hook part (for example, a hook B40, described hereafter) having an upper aperture and connected to the seat part, a stopper (for example, a stopper B413, described hereafter) for closing the upper aperture and preventing the object-to-be-hung hooked to the hook part from being removed, a lock control part (for example, a hook control device B412, described hereafter) for switch-controlling the upper aperture to both closed and open state by engaging the stopper to the upper aperture or releasing the engagement; in which the game machine includes a game medium insertion part (for example, a medal insertion part B734, described hereafter) for inserting a predetermined game medium; the game medium insertion part includes a game medium insertion detection part (for example, a sensor, not shown, embedded in the medal insertion part B734 or a sensor embedded in the card slot B721, described hereafter) for detecting that a predetermined game medium has been inserted; the seat part includes a seating detection part (for example, a seating sensor which is not shown, described hereafter), for detecting that the player is seated; and the lock control part changes the upper aperture from an open-state to a closed-state by the stopper, in response to the game medium insertion detection part detecting the insertion of the predetermined game medium or the seating detection part detecting that the player is seated.

According to the thirteenth aspect of the present invention, in addition to the eleventh aspect, the lock control part changes the upper aperture to a closed-state by the stopper, in response to the detection of the insertion of the game medium or the seating of the player.

In this way, the upper aperture part can enter a closed state by the stopper by not only applying load of the belongings to the hook, but also by detecting the insertion of the game medium or the seating of the player, in addition, because a key for locking is not necessary, the player can concentrate on the game without thinking about the whereabouts of the key or theft of his belongings and the player's sense of enjoyment can be enhanced.

In a fourteenth aspect of the present invention, the game machine according to the thirteenth aspect has a seating detection part which transmits a lock release signal when the seating of the player is not detected and a lock control part which changes the upper aperture from an open-state to a closed-state by the stopper, in response to receiving the lock release signal.

According to the fourteenth aspect of the present invention, in addition to the thirteenth aspect, the seating detection part transmits a lock release signal when the seating of the player is not detected and the stopper enters an open-state in response to the reception of the lock release signal, in this way, because the stopper automatically enters an open-state when the seating is not detected, such as by the player leaving the seat, the player can remove his belongings from the hook part easily, just by standing up from this seat. In addition, because the conventional action of opening the lock and removing the belongings becomes unnecessary, the payer can concentrate on the game without thinking about the whereabouts of the key, and the player's sense of enjoyment can be enhanced.

In a fifteenth aspect of the present invention, the game machine according to a fourteenth aspect of the invention further includes: a time measurement part (for example, a timer B98, described hereafter) for measuring time; in which the time measurement part measures time in response to the transmission of the lock release signal from the seating detection part, and-the lock control part receives the lock release signal and changes the upper aperture from an open-state to a closed-state by the stopper, in response to the passage of a predetermined amount of time measured by the time measurement part.

According to the fifteenth aspect of the present invention, in addition to the fourteenth aspect, the lock control part releases the stopper lock after the time measurement part measures the passage of a predetermined amount of time from the transmission of the lock release signal. In this way, the stopper enters an open-state after a predetermined amount of time has passed since the player stood up from the seat part, in addition, because the stopper can remain in a closed-state until the player stands up from the seat part and reaches the hook part, theft of belongings until the player reaches the hook part can be prevented. Furthermore, the player can concentrate on the game without thinking about the theft of belongings, and the player's sense of enjoyment can be enhanced.

In a sixteenth aspect of the present invention, the game machine according to any one of the twelfth to fifteenth aspects has a seat part which includes a seat shell (for example, a seat shell B70 described hereafter) for covering the surrounding area of the seat part, in which the hook part is attached to the outside of the seat shell.

According to the sixteenth aspect of the present invention, because a hook is attached to the outside of the seat shell which covers the seat part, it is not necessary to place belongings inside the seat shell. In this way, the belongings do not get in the way of the game, and an environment enabling the player to concentrate on the game further can be provided.

In a seventeenth aspect of the present invention, the game machine according to the fifteenth aspect of the invention includes: a photographing (for example, a belongings camera B42, described hereafter) for photographing an image of the object-to-be-hung when the hook part is in a closed-state; in which the display part shows the image of the object-to-be-hung taken by the photographing.

According to the seventeenth aspect of the present invention, in addition to the fifteenth aspect, the image of the object-to-be-hung is taken when the upper aperture of the hook part is in a closed-state and the image is shown in the display part.

In this way, because the player can confirm the state of his belongings at all times, fear of the theft of his belongings can be reduced. In addition, an environment enabling the player to concentrate on the game can be provided and the player's sense of enjoyment can be enhanced.

In an eighteenth aspect of the present invention, the game machine according to the fifteenth aspect of the invention has: a seat part which includes a movement (for example, a traveling part B32, described hereafter), which is provided on the lower part of the seat part, for moving the seat part; and a control which includes a movement control (for example, a CPU B91, described hereafter) for driving the movement.

According to the eighteenth aspect of the present invention, in addition to the fifteenth aspect, because a lockable hook is attached to a mobile seat part, a game can be played without the belongings getting thrown down, even when the terminal device moves. In this way, because the risk of theft due to the belongings getting thrown down is reduced, the player can concentrate on the game further, and the sense of enjoyment can be enhanced.

In the nineteenth aspect of the present invention, the game machine according to the sixteenth aspect of the invention includes: a photographing for photographing an image of the object-to-be-hung when the hook part is in a closed-state; in which the display part shows the image of the object-to-be-hung taken by the photographing.

In a twentieth aspect of the present invention, the game machine according to the sixteenth aspect of the invention has: a seat part which includes a movement, which is provided on the lower part of the seat part, for moving the seat part; and a control which includes a movement control for driving the movement.

In a twenty-first aspect of the present invention, the game machine according to the nineteenth aspect of the invention has, a seat part which includes a movement, which is provided on the lower part of the seat part, for moving the seat part; and a control which includes a movement control for driving the movement.

According to the second aspect of the present invention, a game player can be provided. In which the player can concentrate on the game at ease by preventing theft of belongings and the sense of enjoyment of each player can be enhanced.

The protective cover glass, such as that according to the third aspect of the background art, was not preferable because it was expensive and heavy. In addition, the foregoing protective cover glass was often thick and it was necessary to implement backlight for the liquid crystal display device with a higher luminance than normal. Furthermore, this caused new problems to arise, such as the narrowing of the viewing angle due to thickness.

Recently, in particular, a touch panel is provided on the surface of the monitor screen of a liquid crystal device and the liquid crystal device and the touch panel is often sold as an integrated module. In these instances, if a protective cover glass is placed between the touch panel and the liquid crystal screen, this causes the manufacturing process to become complicated, and because this cannot be implemented as is, this can lead to increased costs.

In light of the foregoing issues, an object of the present invention is to provide a game machine which provides a display, such as a liquid crystal display device, of the game machine within which a plurality of game media are stored separately from a game medium storage part within which the game media are saved and prevents the theft of the game media by misconduct occurring from destruction of the display or the like.

The present invention provides a game machine such as that below, in order to overcome the foregoing problems.

In a twenty-second aspect of the present invention, a game machine includes: a game controller (for example, an input operation part C72, described hereafter) for receiving input from a player; a flat display (for example, a liquid crystal monitor C813, described hereafter) for receiving externally or generating internally and showing a game image, generated according to a game program; and a seat (for example, a seat C50, described hereafter) for seating the player; in which the flat display is provided separately from the game machine, is normally stored within a storage part (for example, a liquid crystal monitor storage part C62, described hereafter) for storing the flat display, and includes a driving mechanism (for example, a liquid crystal monitor driving control device C63, described hereafter) for moving the flat display to a predetermined position and into a state enabling play when the game is started, and on the other hand, automatically stores the flat display into the storage part when the game is completed.

According to the twenty-second aspect of the present invention, the flat display, provided separately from the game machine, is automatically moved to a predetermined position by the driving mechanism when the game starts and automatically stored in the storage part in the main game machine body when the game is completed.

In this way, theft of the flat display itself can be reduced when in a normal state, and problems such as the flat display getting in the way when the player is seated in the seat or forgetting to store the flat display can be prevented. Furthermore, the automatic actions of the flat display such as these can, as a result, enhance a sense of high-quality regarding the game machine. When movement-operating the flat display which is connected to the connection device, a method for automatic movement can be implemented, as in the foregoing, and a method for manual movement can be implemented, as well.

In a twenty-third aspect of the present invention, a game program includes: a main game machine body which includes a memory (for example, a database C84, described hereafter) for storing a game program, a control (for example, a main control device C80, described hereafter) for executing the game program stored in the memory, an input (for example, an input operation part C72, described hereafter) for receiving input from the player, and a game medium storage (for example, a medal collection part C73, described hereafter), having a game medium insertion part and a game medium payout part, for storing game media inserted from the game medium insertion part; a flat display (for example, a liquid crystal monitor C613, described hereafter) for showing game image generated by the control according to input from the input; and a transmitting part (for example, a transmitting part C64, described hereafter) for transmitting the game image to the flat display; in which the flat display part is provided separately from the main game machine body via a connection device (for example, a first support arm C611 and a second support arm C612).

According to the twenty-third aspect of the present invention, because the flat display and the main game machine body, having a game medium storage part within which a plurality of game media is stored, are provided separately by placing a connection device therebetween, theft by misconduct occurring from destruction of the flat display or the like can be prevented without providing a protective cover glass, such as that described earlier. In addition, because game media, such as medals and coins, cannot be stolen even if the flat display itself is destroyed since it is separate from the main game machine body, destruction of the flat display itself can also be prevented.

In a twenty-fourth aspect of the present invention, the game machine according to the twenty-third aspect of the invention has: a main game machine body, to which a seat (for example, a seat C50, described hereafter) for enabling the player to play in a seated state is provided integrally, which includes a storage part (for example, a liquid crystal monitor storage part C62, described hereafter) for storing the flat display part; and a connection device which includes, at the least, a connection rod (for example, a first support arm C611 and a second support arm C612, described hereafter) of which one end is fixed to the main game machine body and the other end is connected to the flat display; in which the connection device moves the flat display part to a predetermined position and into a state enabling play from a state of storage within the storage part during a normal state, with the reception of a game start signal from the control as a trigger, and on the other hand, is connected to a driving mechanism (for example, a liquid crystal monitor driving control device C63, described hereafter) for automatically storing the flat display into the storage part, with the reception of a game completion signal from the control as a trigger.

Here, the predetermined position is a position placed facing the player seated in the seat, and can be adjusted by the player.

According to the twenty-fourth aspect of the present invention, because the player can move the flat display automatically by the driving mechanism according to the start of the game and can store it to the storage part of the main game machine body automatically at the completion of the game, theft of the flat device itself can be reduced and problems such as the flat display getting in the way when the player is seated in the seat or forgetting to store the flat display can be prevented. Furthermore, the automatic actions of the flat display such as these can, as a result, enhance a sense of high-quality regarding the game machine. When movement-operating the flat display which is connected to the connection device, a method for automatic movement can be implemented, as in the foregoing, and a method for manual movement can be implemented, as well.

In a twenty-fifth aspect of the present invention, the game machine according to the twenty-third or twenty-fourth aspect of the invention has a game medium storage which includes a level sensor (for example, a remaining amount sensor C76, described hereafter) for transmitting an empty signal, in response to detecting that the storage level of the game media stored within the game medium storage is below a predetermined level.

According to the twenty-fifth aspect of the present invention, the game machine includes a sensor for determining whether the storage level of the game media stored within the game medium storage is below a predetermined level and transmitting an empty signal when it is below a predetermined level.

In this way, because the empty signal can be transmitted outside, such as to the arcade staff, when the remaining amount of the game media is below a predetermined level, the staff can be prompted to replenish the game media before the game medium storage level reaches zero.

In a twenty-sixth aspect of the present invention, a game machine includes: a main game machine body which includes a memory (for example, a database C84, described hereafter) for storing a game program, and a main control (for example, a main control device C80 described hereafter) for executing the game program stored in the memory; a main terminal device body which includes an input (for example, an input operation part C72, described hereafter) for receiving input from the player, a game medium storage (for example, a medal collection part C73, described hereafter), having a game medium insertion part and a game medium payout part, for storing inserted game media, and a sub-control (for example, a sub-control device C90, described hereafter) for transmitting game input data according to input from the input, connected by wireless connection to the main game machine body, to the main control of the main game machine body; a plurality of terminal devices which includes a flat display (for example, a liquid crystal monitor C613, described hereafter) for showing game image generated by the main control according to input from the input and the game program and a transmitting part (for example, a transmitting part C64, described hereafter) for transmitting the game image to the flat display; and a main display (for example, a main display device C22, described hereafter) for showing images based on the image data output from the main control; in which the main control receives a plurality of game input data from the plurality of terminal devices, generates a single game data according to the game program, based on these plural game input data, generates image data which is shared with all of the terminal devices, based on the generated single game data, and outputs this data to the main display; and the flat display part is provided separately from the main terminal device body via a connection device (for example, a first support arm C611 and a second support arm C612).

According to the twenty-sixth aspect of the present invention, in a multi-player-type game machines in which numerous players participate, such as a multi-player game, because the flat display and the main terminal device body, having a game medium storage part within which a plurality of image media is stored, are provided separately with a connection part therebetween, theft by misconduct occurring from destruction of the flat display or the like can be prevented without providing a protective cover glass, such as that described earlier. In addition, because game media, such as medals and coins, cannot be stolen even if the flat display itself is destroyed, since it is a separate device, destruction of the flat display itself can also be prevented.

In a twenty-seventh aspect of the present invention, the game machine according to the twenty-sixth aspect of the invention has: a main terminal device body, to which a seat (for example, a seat C50, described hereafter) for enabling the player to play in a seated state is provided integrally, which includes a storage part (for example, a liquid crystal monitor storage part C62, described hereafter) for storing the flat display; a connection device which includes, at the least, a connection rod (for example, a first support arm C611 and a second support arm C612, described hereafter) of which one end is fixed to the main terminal device body and the other end is connected to the flat display; in which the connection device moves the flat display part to a predetermined position and into a state enabling play from a state of storage within the storage part during a normal state, with the reception of a game start signal from the main control as a trigger, and on the other hand, is connected to a driving mechanism (for example, a liquid crystal monitor driving control device C63, described hereafter) for automatically storing the flat display into the storage part, with the reception of a game completion signal from the main control by the sub-control as a trigger.

According to the twenty-seventh aspect of the present invention, in a multi-player-type game machines in which numerous players participate, such as a multi-player game, because the player can move the flat display automatically by the driving mechanism according to the start of the game and can store it to the storage part of the main game machine body automatically at the completion of the game, theft of the flat device itself can be reduced and problems such as the flat display getting in the way when the player is seated in the seat or forgetting to store the flat display can be prevented. Furthermore, the automatic actions of the flat display such as these can, as a result, enhance a sense of high-quality regarding the game machine. When movement-operating the flat display which is connected to the connection device, a method for automatic movement can be implemented, as in the foregoing, and a method for manual movement can be implemented, as well.

In a twenty-eighth aspect of the present invention, the game machine according to the twenty-sixth or twenty-seventh aspect of the invention has a game medium storage which includes a level sensor (for example, a remaining amount sensor C76, described hereafter) for transmitting an empty signal, in response to detecting that the storage level of the game media stored within the game medium storage is below a predetermined level.

According to the twenty-eighth aspect of the present invention, the game machine includes a sensor for determining whether the storage level of the game media stored within the game medium storage is below a predetermined level and transmitting an empty signal when it is below a predetermined level.

In this way, because the empty signal can be transmitted outside, such as to the arcade staff, when the remaining amount of the game media is below a predetermined level, the staff can be prompted to replenish the game media before the game medium storage level reaches zero.

According to the third aspect of the present invention, because a liquid crystal display device of the game machine within which a plurality of game media are stored is provided separately from a game medium storage part within which the game media are saved, with a connection device placed therebetween, theft of game media by misconduct occurring from destruction of the display or the like can be prevented.

Further features of the invention, its nature, and various advantages will be apparent from the accompanying drawings and the following detailed description of the invention,

### BRIEF DESCRIPTION OF THE DRAWINGS

FIG. 1A is a perspective view showing an outward aspect of a game machine A1 according to an example of a preferred embodiment of the present invention;

FIG. 2A is a perspective view showing an outward aspect of a terminal device A30 of the game machine A1;

FIG. 3A is a perspective view of the seat of the terminal device A30;

FIG. 4A is a perspective view showing a state in which a sub-monitor of the terminal device A30 is stored within a sub monitor storage part;

FIG. 5A is a perspective view showing a state in which the display screen of the sub-monitor of the terminal device A30 is turned toward the player;

FIG. 6A is a perspective view showing a state in which the position of the sub-monitor of the terminal device A30 is adjusted;

FIG. 7A is a block diagram showing the overall configuration of the game machine A1;

FIG. 8A is a block diagram showing a configuration of a main control device A80 of the game machine A1;

FIG. 9A is a block diagram showing a configuration of a sub-control device A90 of the game machine A1;

FIG. 10A is a main flowchart showing a processing in which the terminal device A30 performs notification;

FIG. 11A is a main flowchart showing a processing in which the terminal device A30 performs notification;

FIG. 12A is a flowchart showing a processing in which the terminal device A30 performs a first notification processing;

FIG. 13A is a flowchart showing a processing in which the terminal device A30 performs a time measurement/card detection processing;

FIG. 14A is a flowchart showing a processing in which the terminal device A30 performs a second notification processing;

FIG. 15A is a flowchart showing a processing in which the terminal device A30 fixes the sub-display part A61 and performs notification;

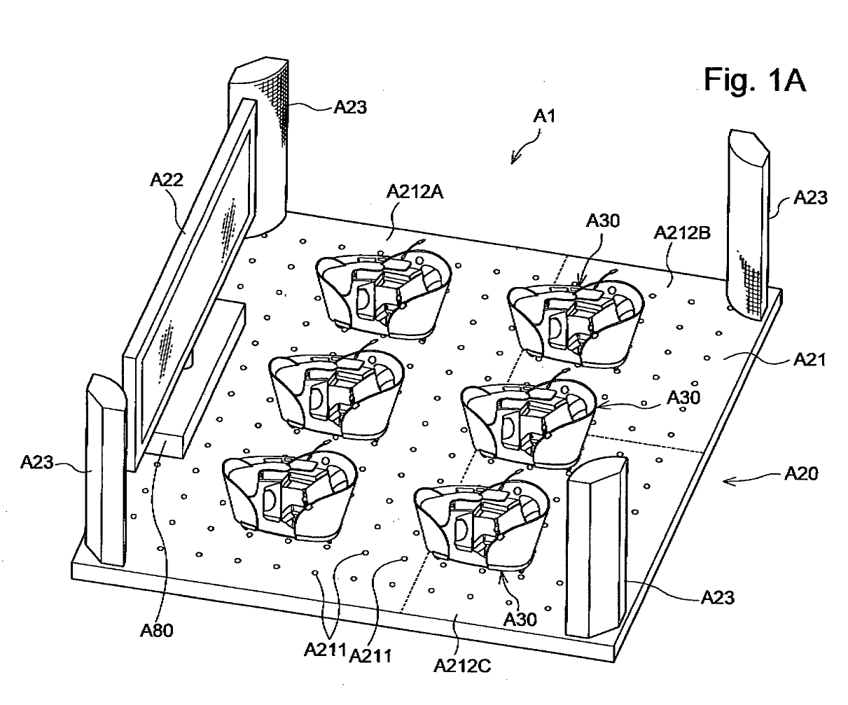

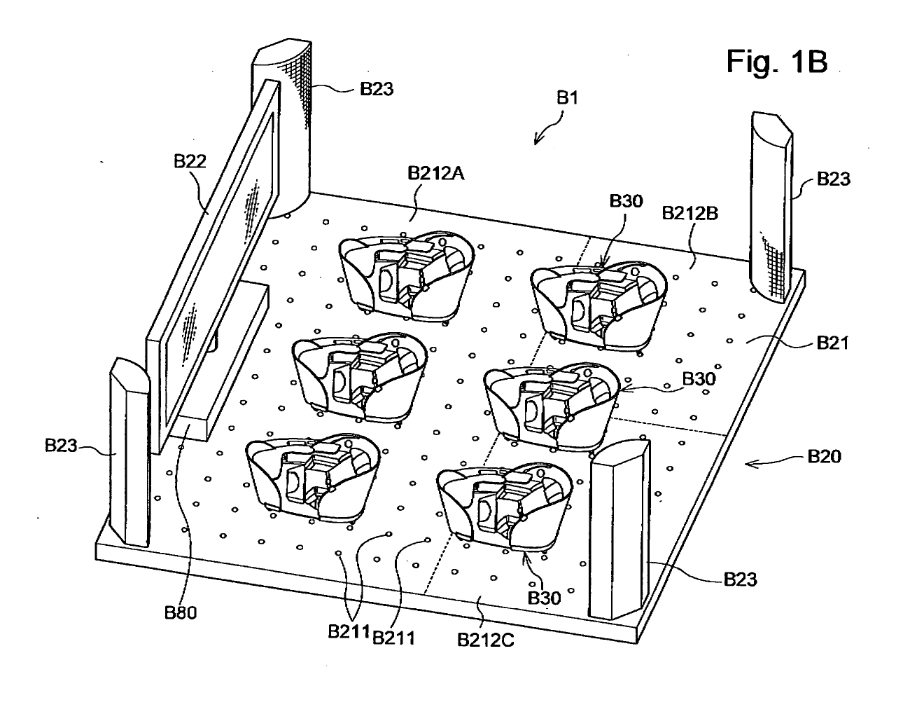

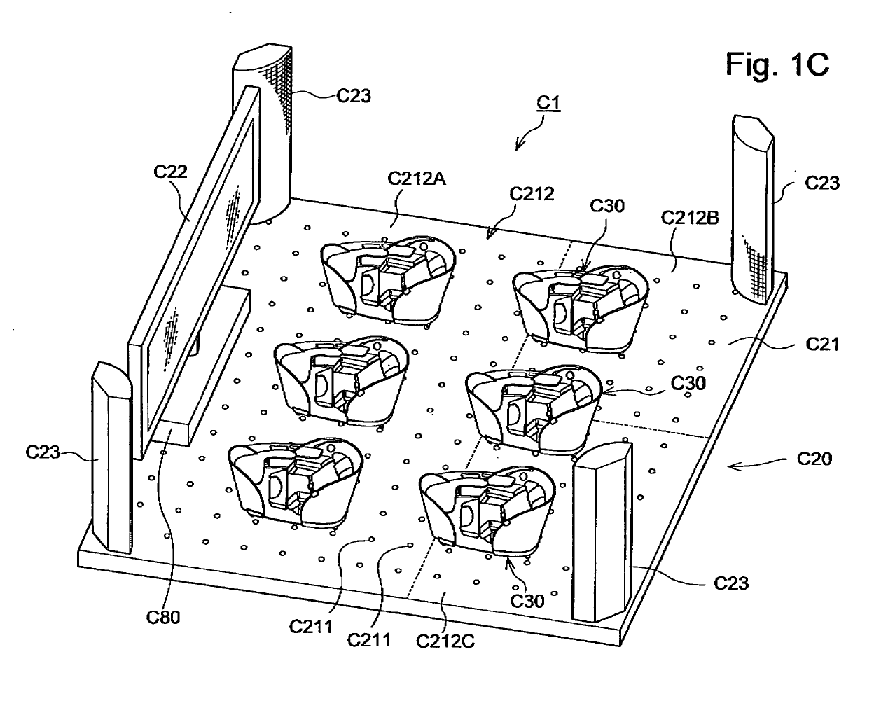

FIG. 1B is a perspective view showing an outward aspect of a game machine B1 according to an example of a preferred embodiment of the present invention;

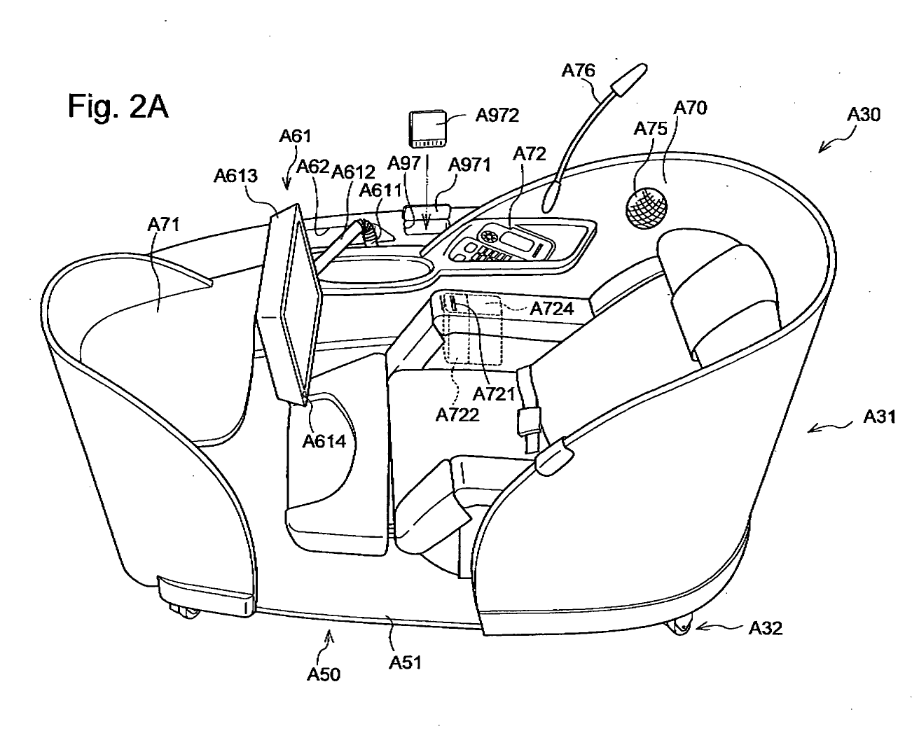

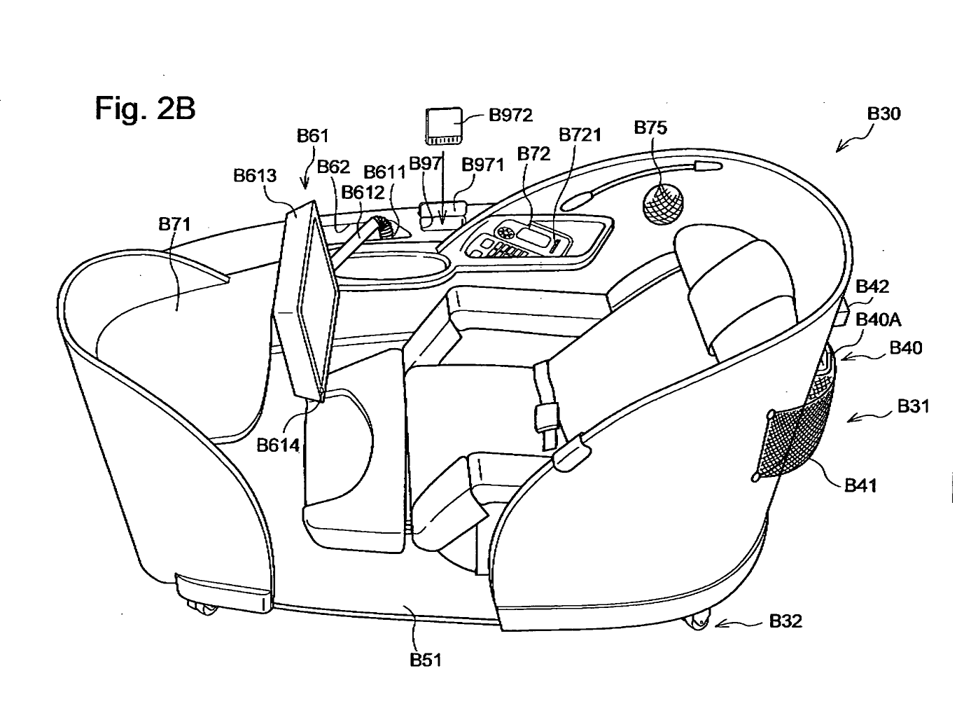

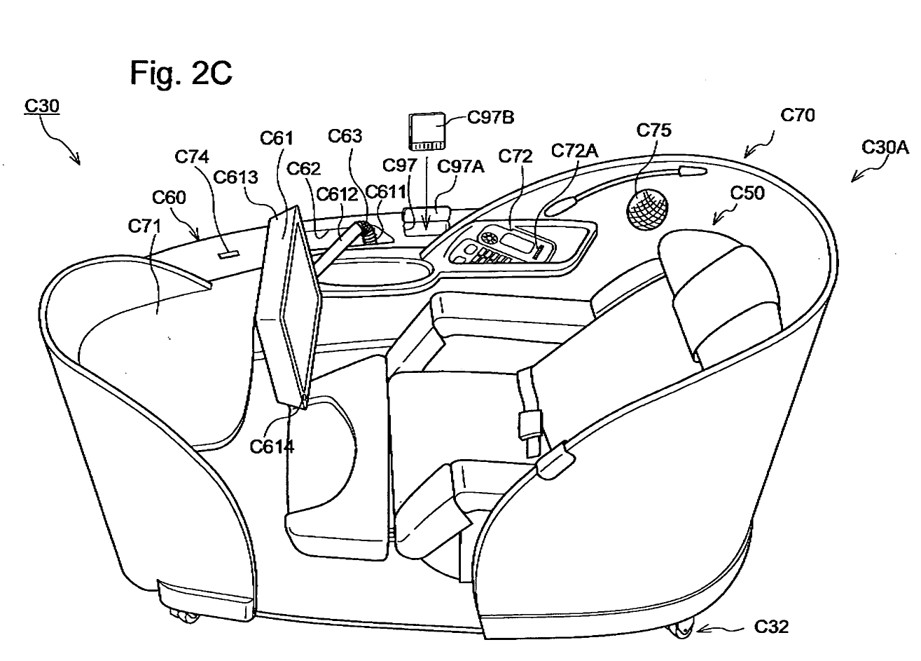

FIG. 2B is a perspective view showing an outward aspect of a terminal device B30 of the game machine B1;

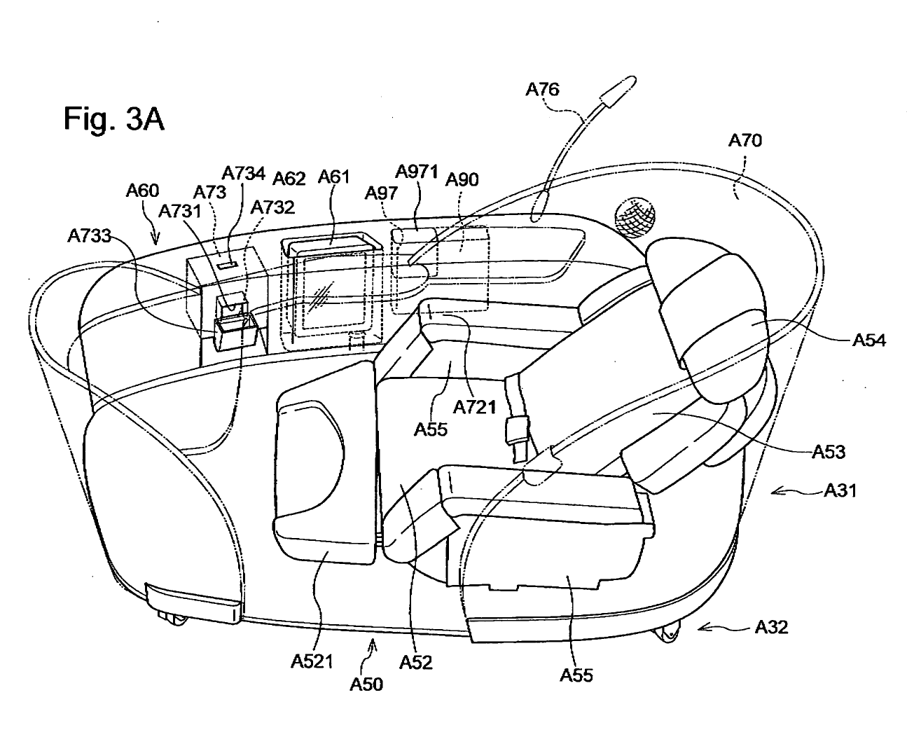

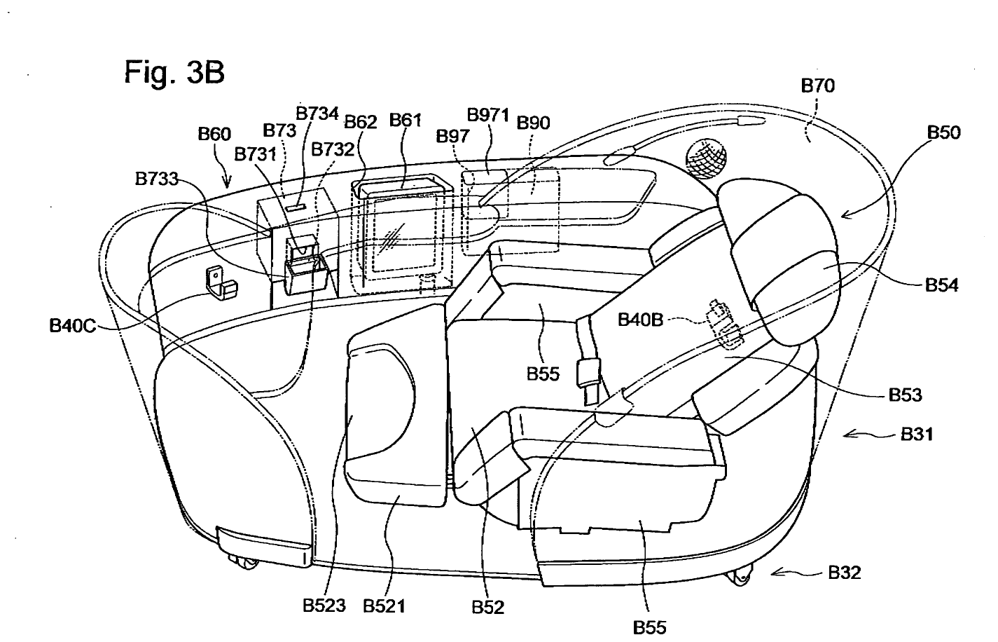

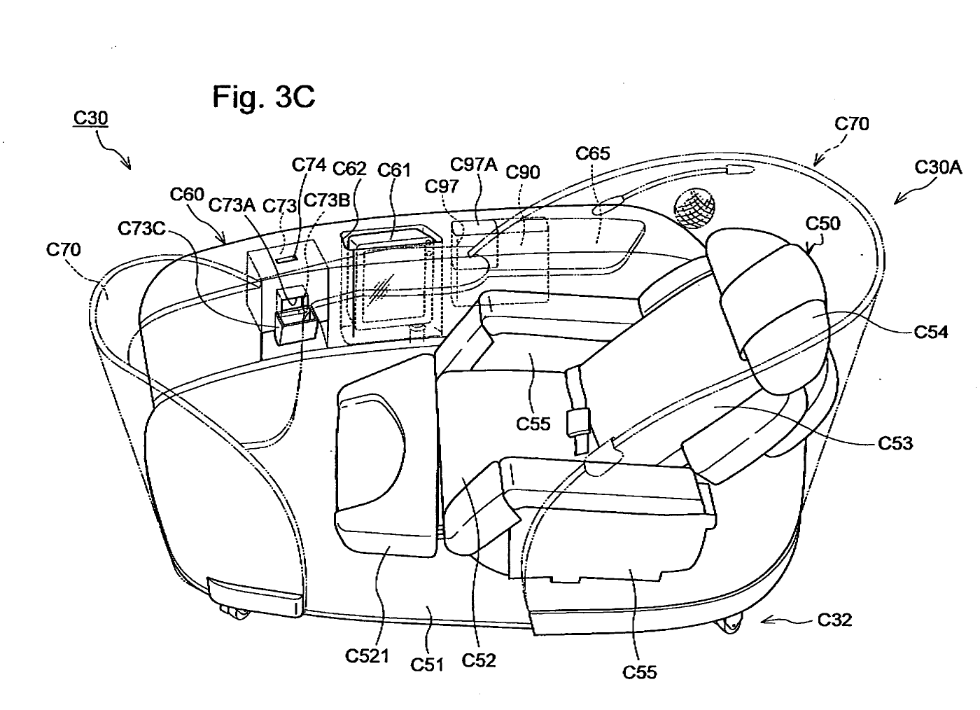

FIG. 3B is a perspective view of the seat of the terminal device B30;

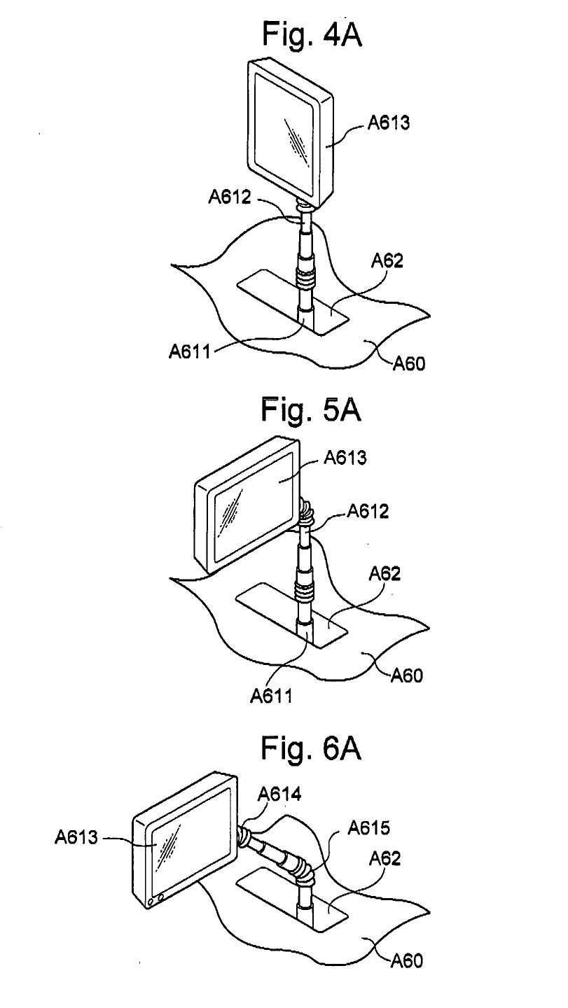

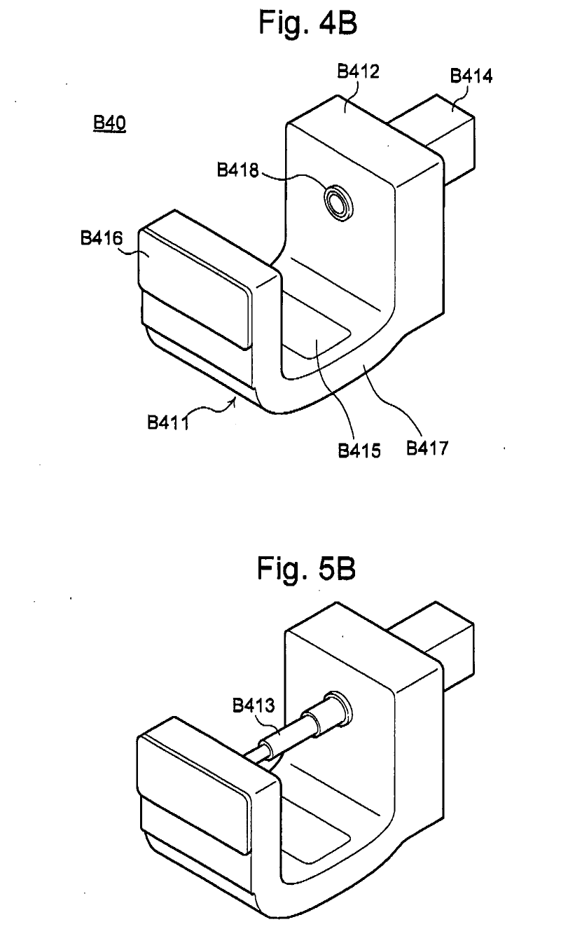

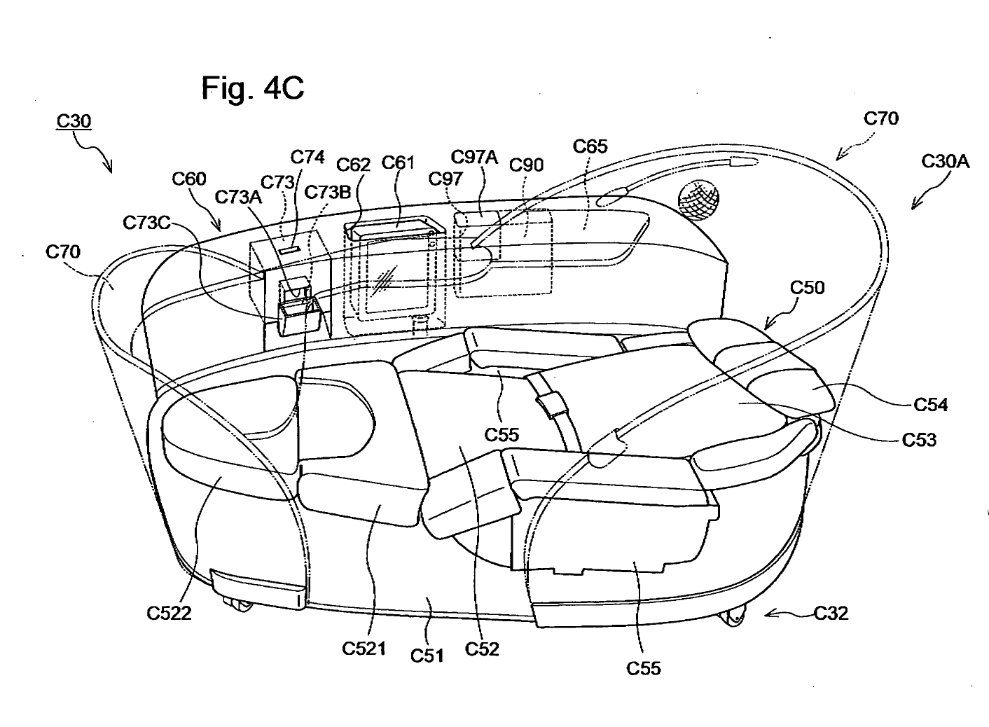

FIG. 4B is a perspective view of a hook B4 of the terminal device B30;

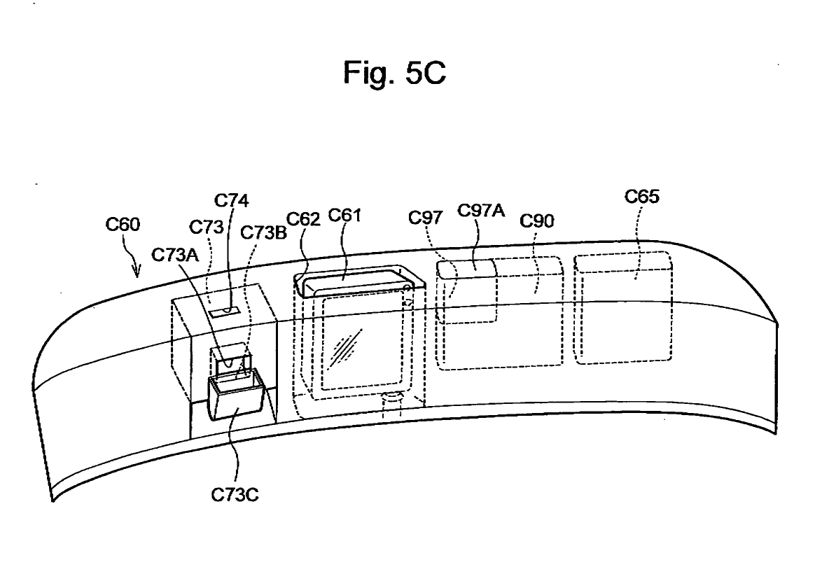

FIG. 5B is a perspective view of a state in which the stopper B413 of the hook 14 of the terminal device B30 is extended;

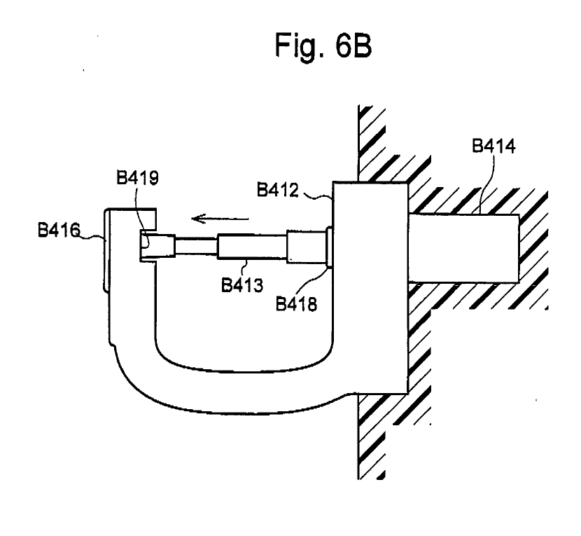

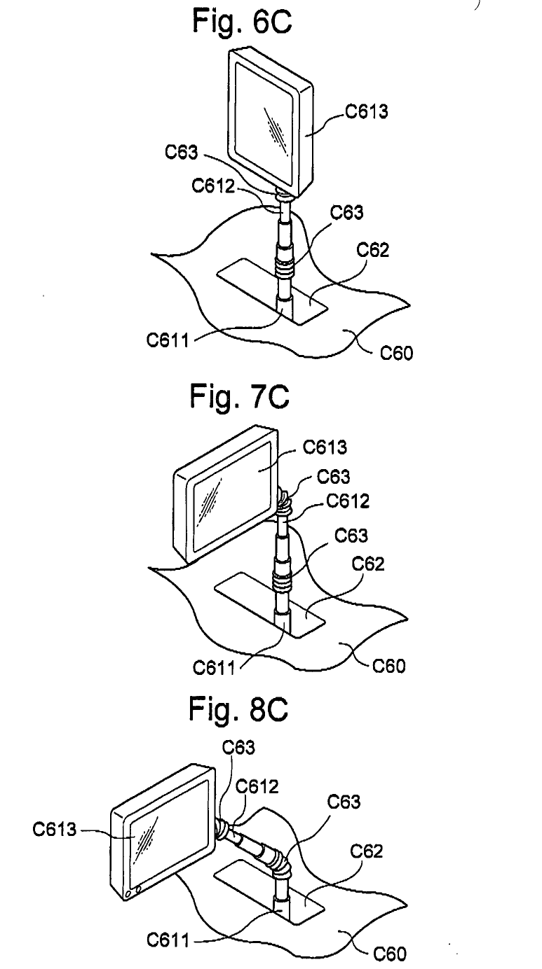

FIG. 6B is a side view of the hook B40 of the terminal device B30;

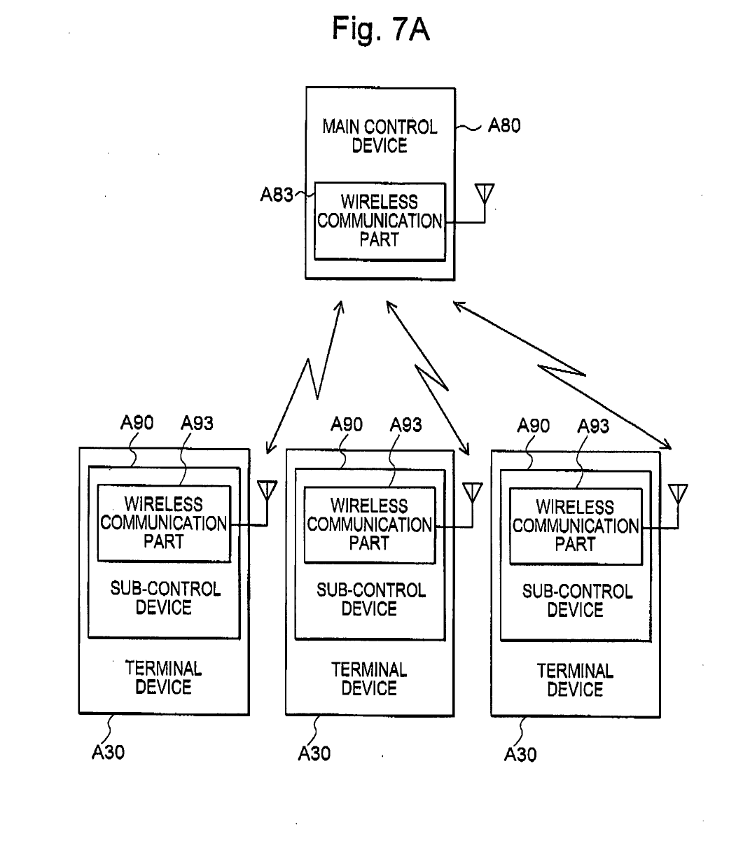

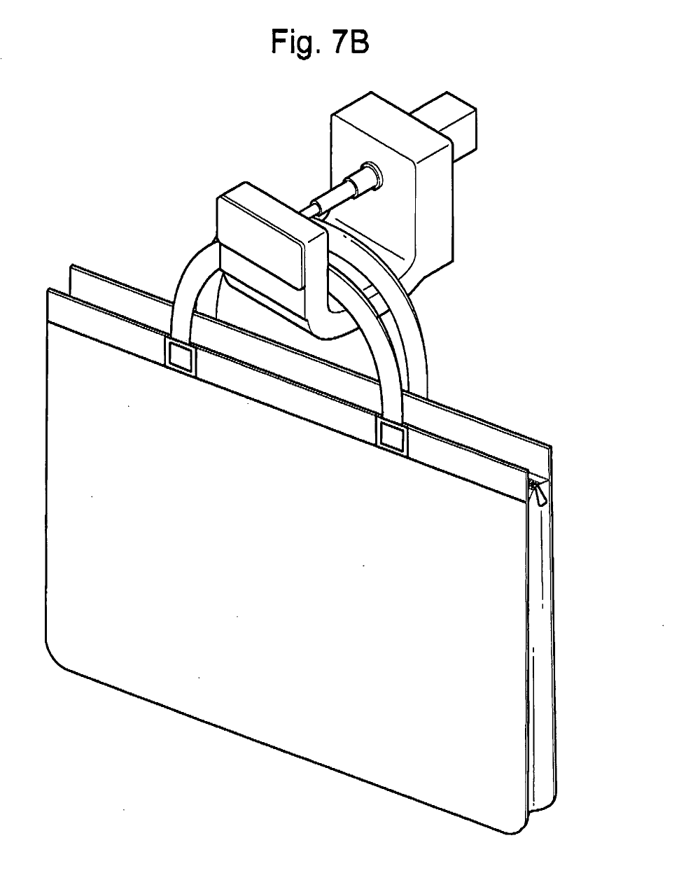

FIG. 7B is a diagram showing an embodiment of a state in which belongings are hung on the hook B40 of the terminal device B30;

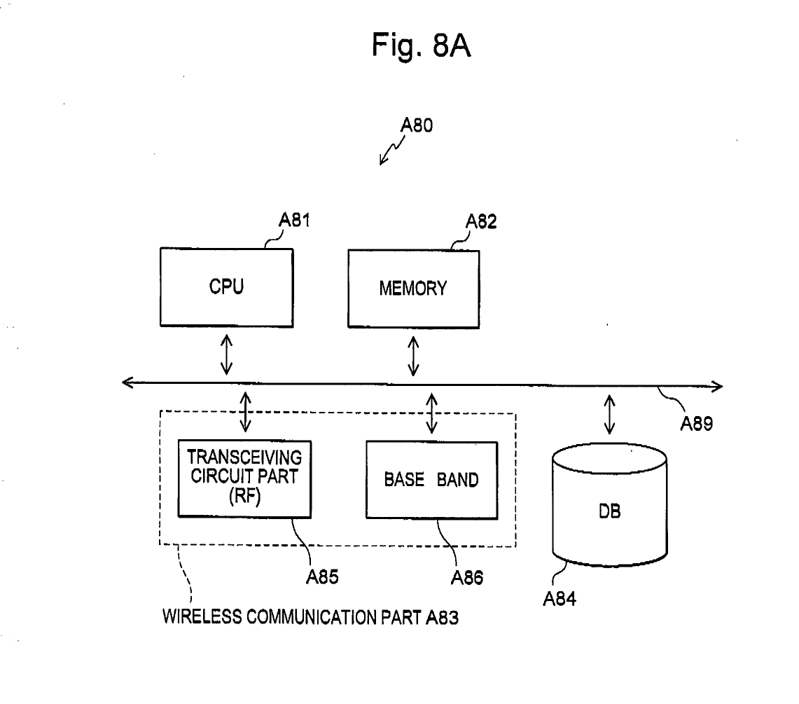

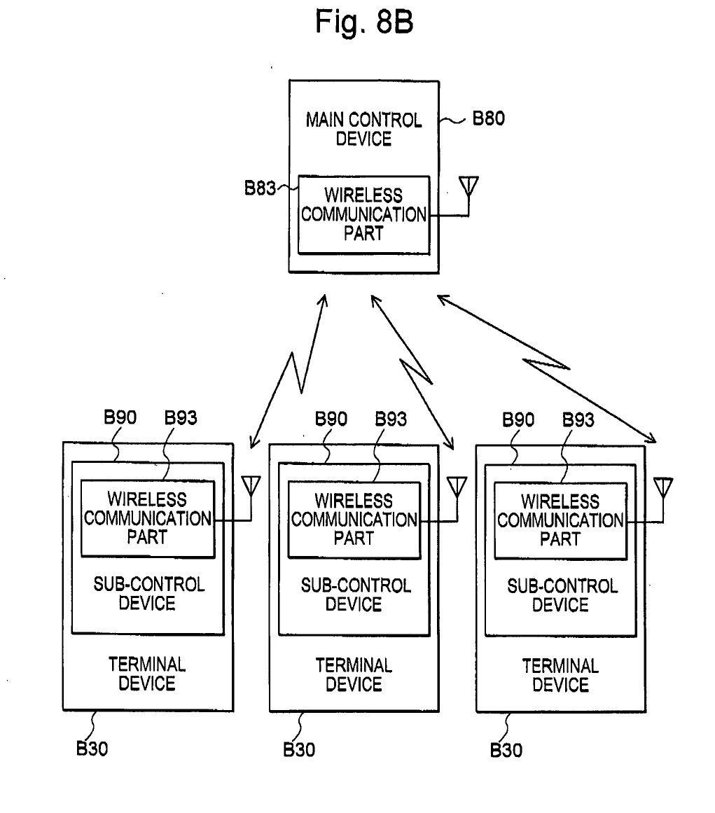

FIG. 8B is a block diagram showing the overall configuration of the game machine B1;

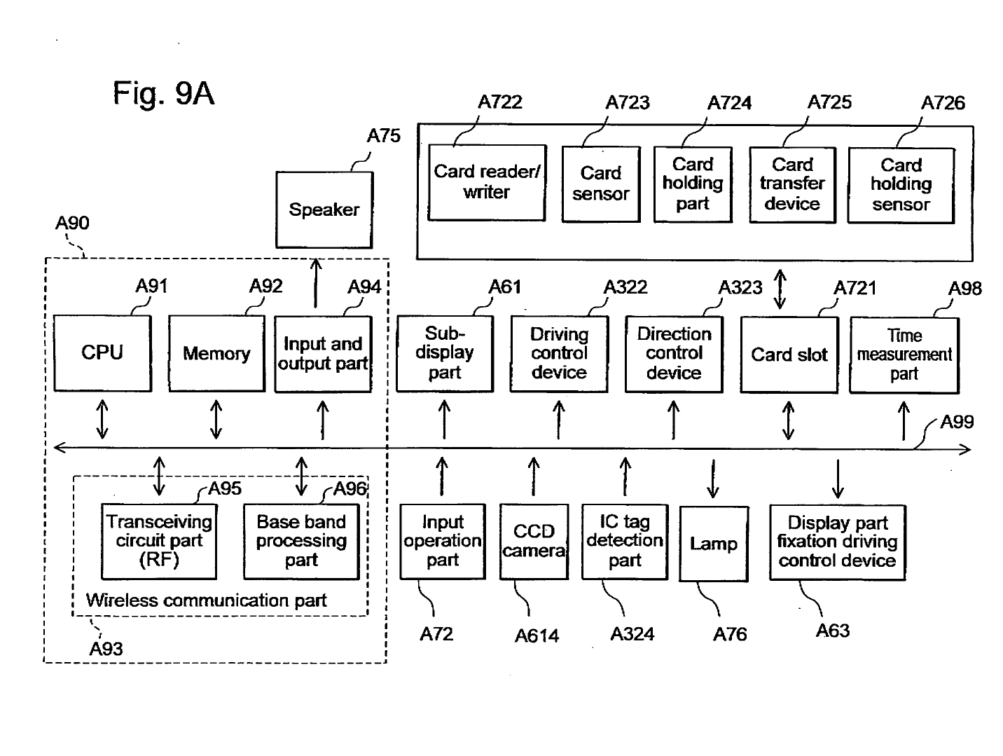

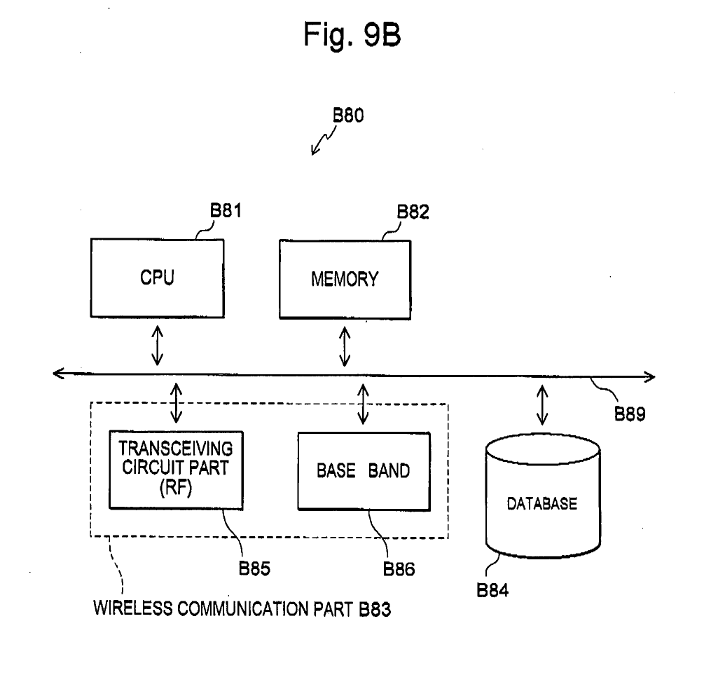

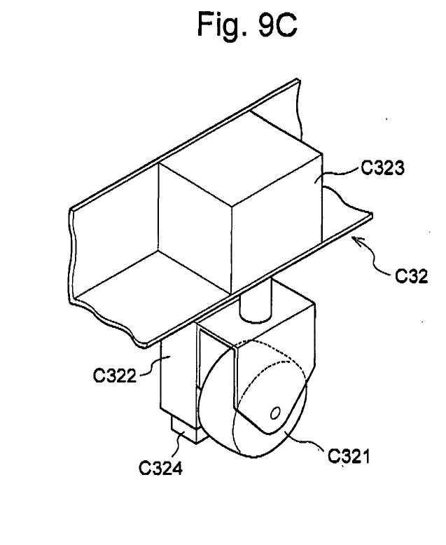

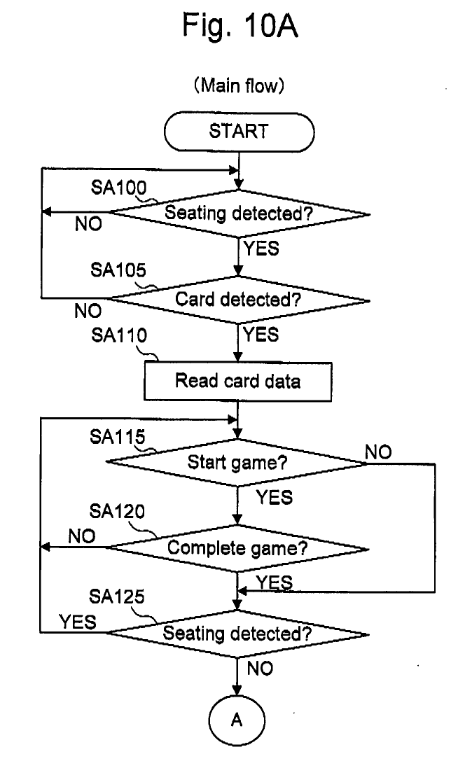

FIG. 9B is a block diagram showing a configuration of a main control device B80 of the game machine B1;

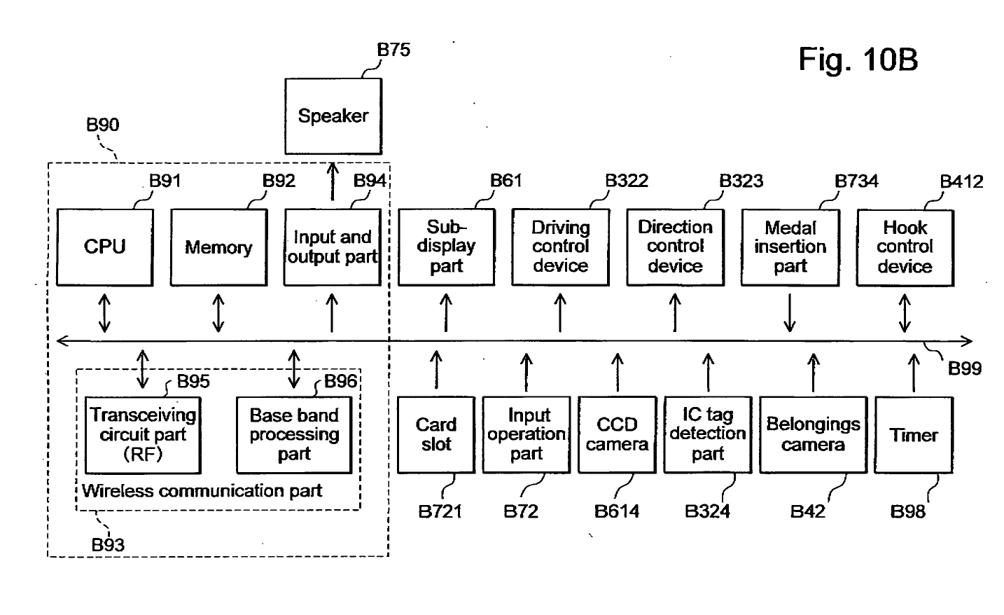

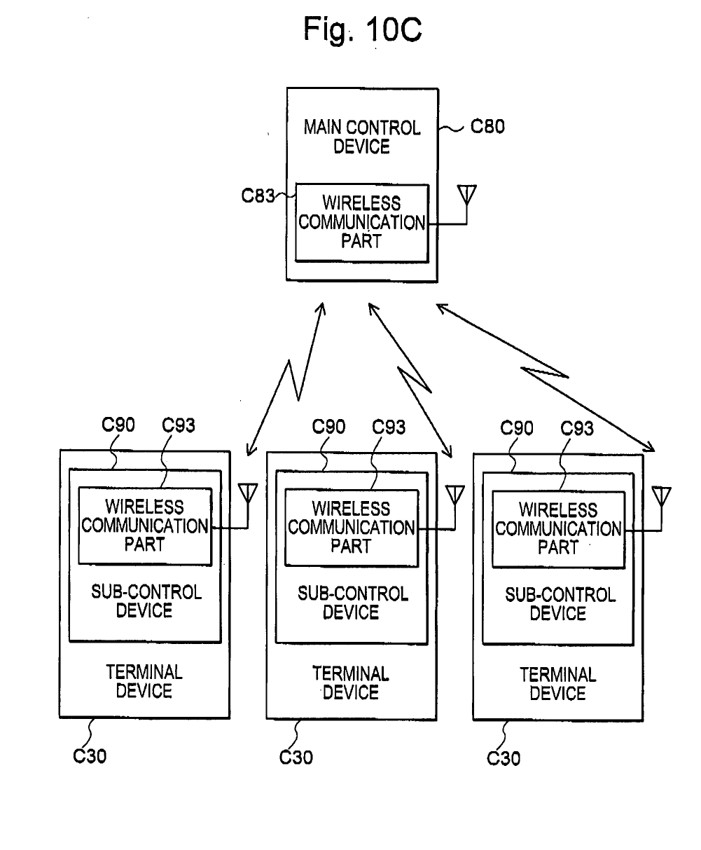

FIG. 10B is a block diagram showing a configuration of a sub-control device B90 of the game machine B1;

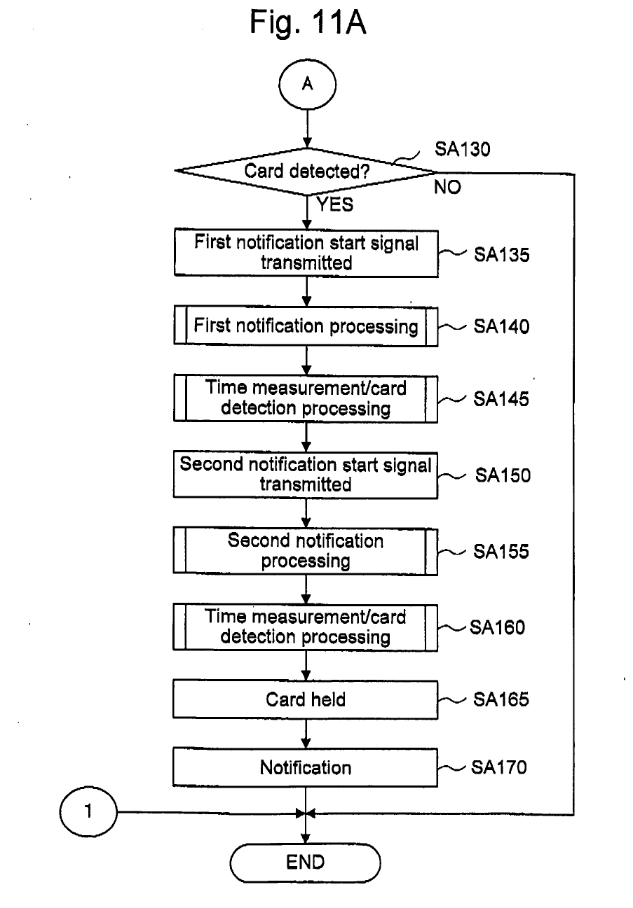

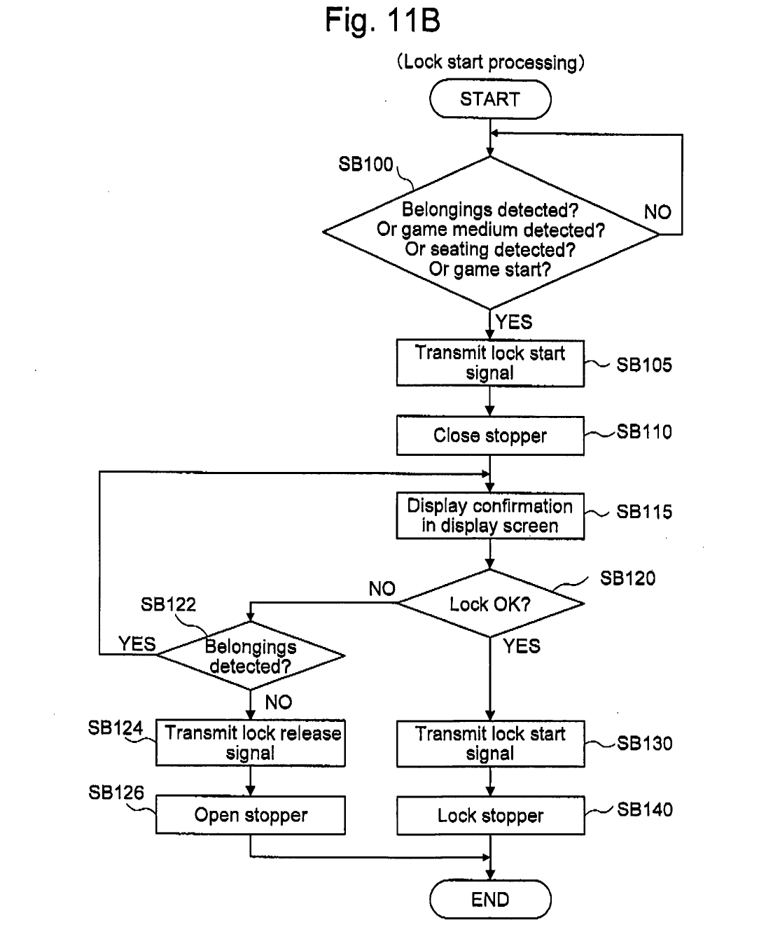

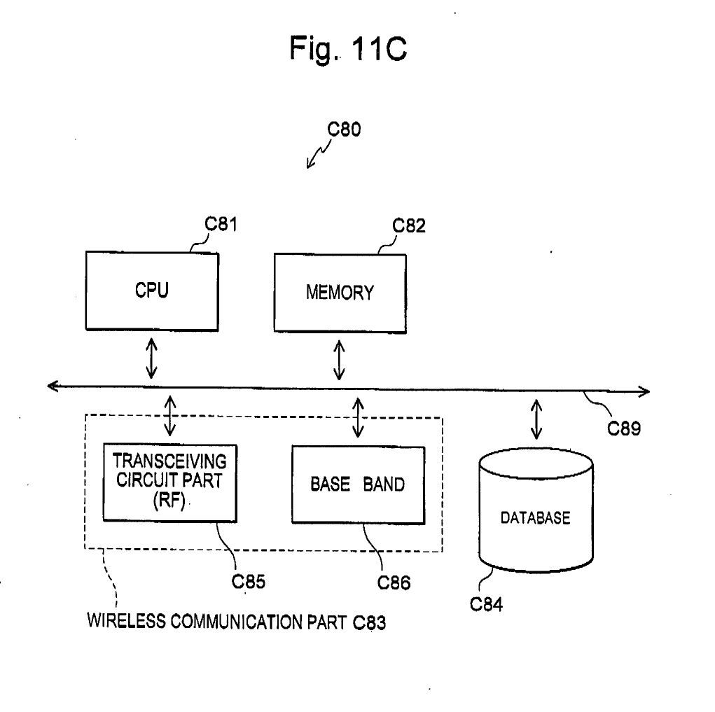

FIG. 11B is a flowchart showing a processing in which the hook B40 of the terminal device B30 is locked;

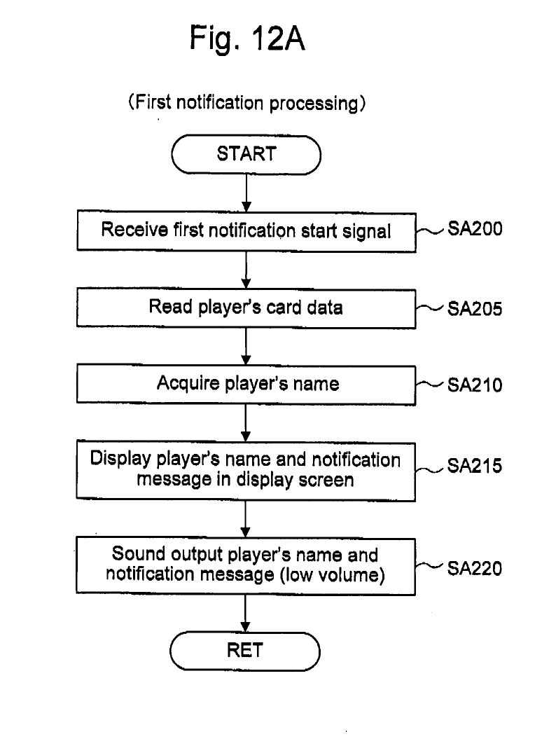

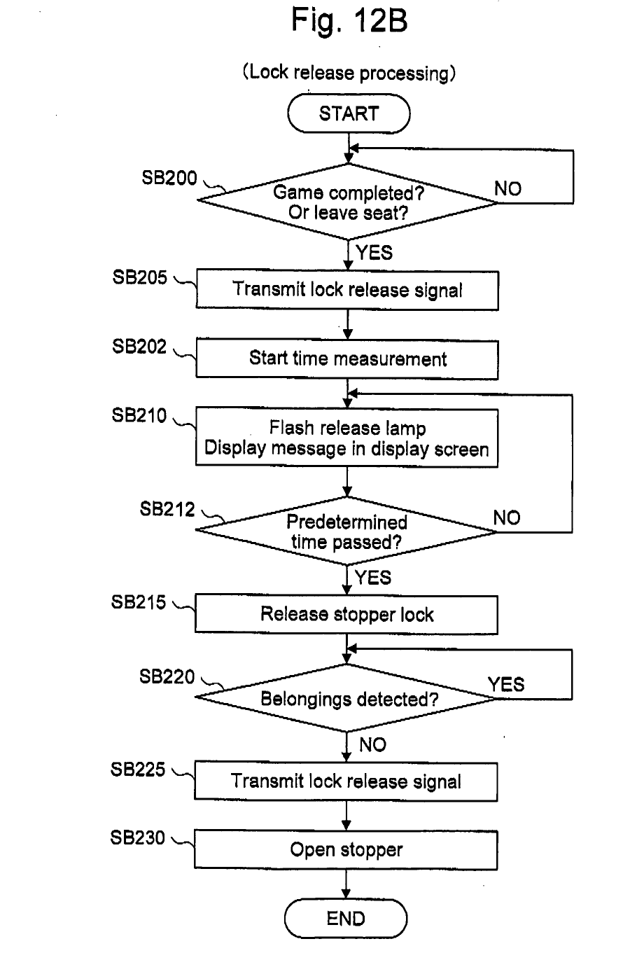

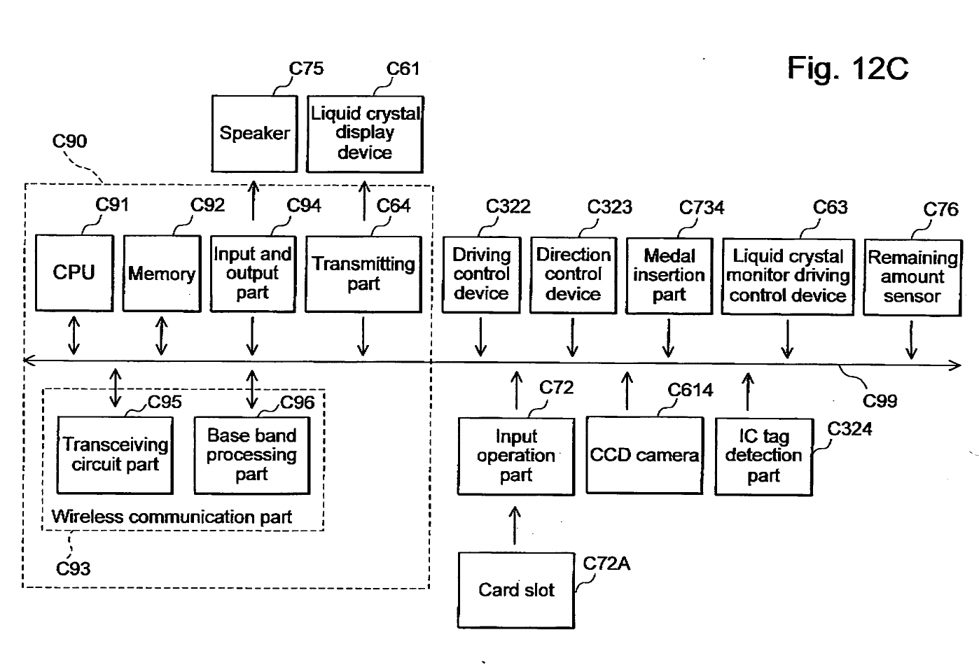

FIG. 12B is a flowchart showing a processing in which the hook B40 of the terminal device B30 is unlocked:

FIG. 1C is a perspective view showing an outward aspect of a game machine according to an example of a preferred embodiment of the present invention;

FIG. 2C is a perspective view showing an outward aspect of a terminal device of the game machine;

FIG. 3C is a perspective view of the seat of the terminal device in seat mode;

FIG. 4C is a perspective view of the seat of the terminal device in bed mode;

FIG. 5C is a perspective view showing a state in which a liquid crystal display device is stored within a side unit of the terminal device;

FIG. 6C is a perspective view showing a state in which a liquid crystal monitor of the terminal device is pulled out from within the liquid crystal monitor storage part;

FIG. 7C is a perspective view showing a state in which the display screen of the liquid crystal monitor of the terminal device is turned toward the player;

FIG. 8C is a perspective view showing a state in which the position of the liquid crystal monitor of the terminal device is adjusted;

FIG. 9C is an enlarged perspective view of one section of a traveling part of the terminal device;

FIG. 10C is a block diagram showing an overall configuration of the game machine and the terminal device;

FIG. 11C is a block diagram showing a configuration of a main control device of the main game machine body;

FIG. 12C is a block diagram showing a configuration of a sub-control device of the terminal device;

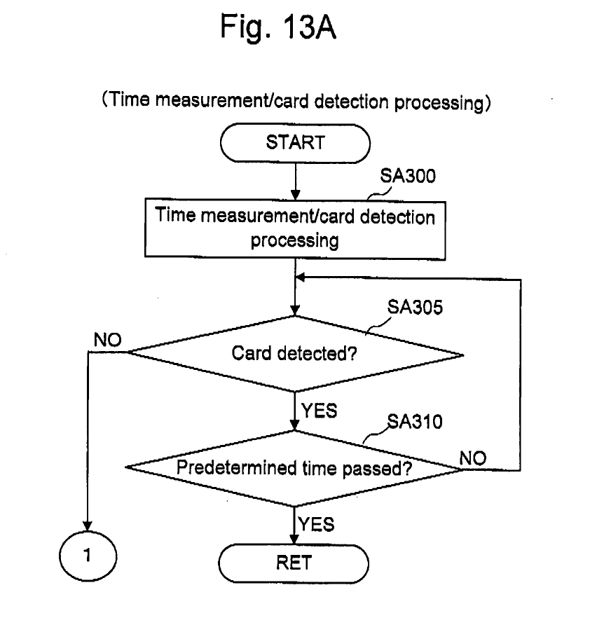

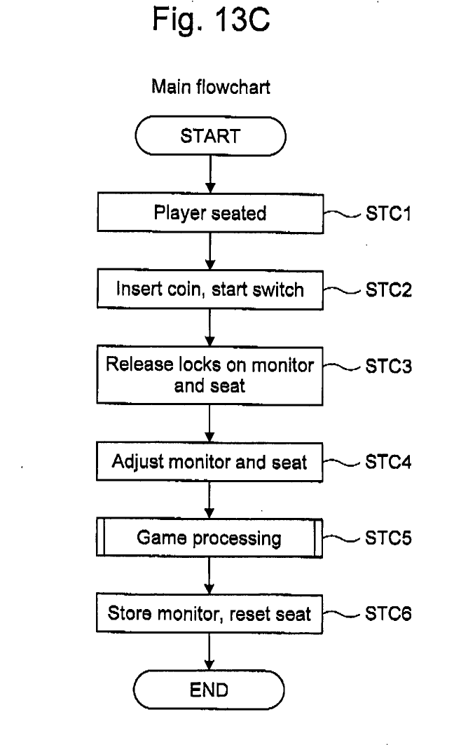

FIG. 13C is a main flowchart of a game executed in the game machine;

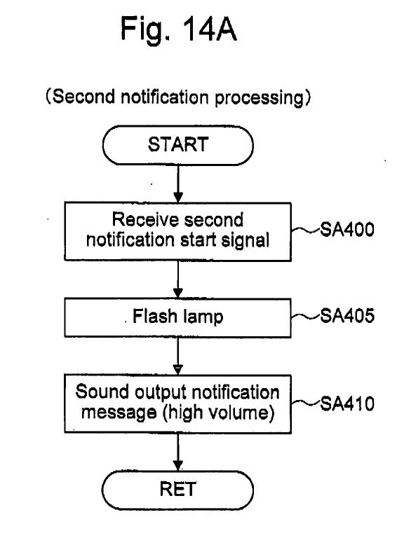

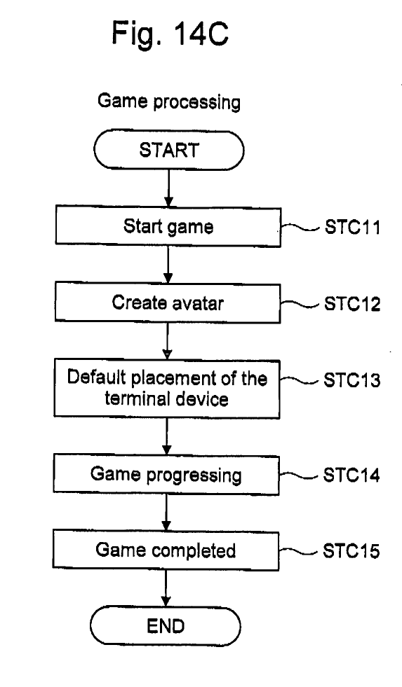

FIG. 14C is a flowchart of the game processing of the game program executed in the game machine; and

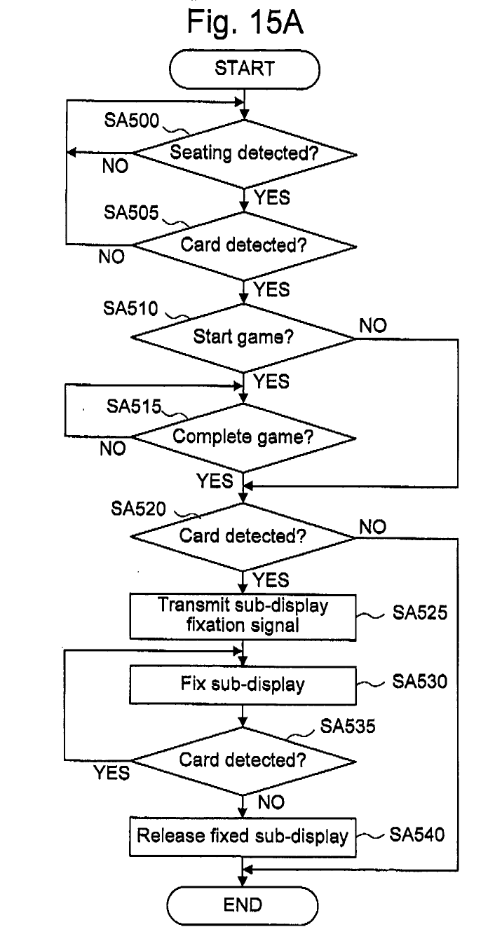

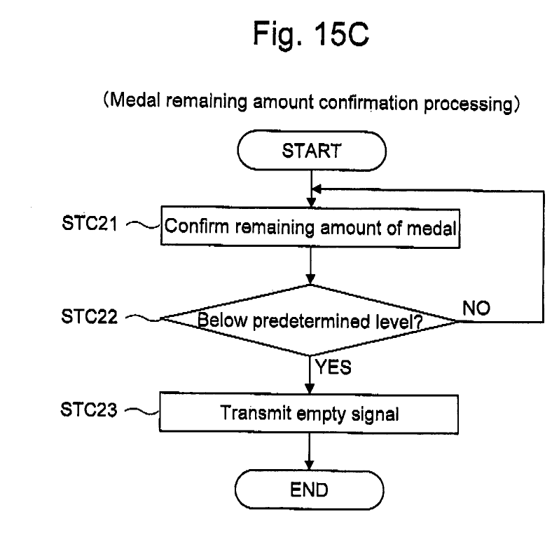

FIG. 15C is a flowchart of a remaining amount confirmation processing of the game medium executed in the game machine.

### DESCRIPTION OF THE PREFERRED EMBODIMENTS

The preferred embodiments of the present invention are described below, with reference to the drawings.

Overall Configuration of the Game Machine

FIG. 1A is a perspective view showing an outward aspect of the game machine A1 according to an embodiment of the present invention.

The game machine A1 is a multi-player game machine, including a main game machine body A20 which includes a flat, rectangular play area A21 and a plurality of terminal devices A30 which are placed on this play area A21.

Aside from the play area A21, the main game machine body A20 includes a main display device A22 which is placed along one side of the play area A21, a speaker device A23 which is placed in the four corners of the play area A21, and a main control device A80 for controlling these main display device A22 and speaker device A23.

The play area A21 is divided into a plurality of sub-areas A212. As these sub-areas A212, there are city areas A212A, ocean areas A212B, and forest areas A212C. In addition, IC tags A211 are buried in grid-form in the play area A21. Positional information of the inside of the play area A21 is stored to this IC tag A211.

The main display device A22 is a large projector display device. The main display device A22 is not limited thereto and can also be a large monitor.

The main control device A80 can communicate with each terminal device A30 bi-directionally through wireless LAN and can provide each player with a common virtual space by executing the predetermined game program and bi-directionally communicating with each terminal device A30.

Each terminal device A30 is placed facing towards the main display device A22. This terminal device A30 is connected to the main control device A80 through wireless LAN and can be moved over the play area A21 according to the instructions from the main control device A80 or by player operation.

FIG. 2A is a perspective view showing an outward aspect of each terminal device A30.

The terminal device A30 includes a seat A31, a traveling part A32 which supports this seat A31 from beneath and, in addition, moves it over the player area A21, and lamps A76.

In addition, an IC tag detection part A324 for detecting IC tags A211, which are buried in the play area A21, is provided below the driving control device A322 of the traveling part A32.

Configuration of the Seat

FIG. 2A is a perspective view of the seat A31.

Seat A31 includes a main seat body A50, a side unit A60 which is provided along one side surface of the main seat body A50, and a seat shell A70 which surrounds the main seat body A50 on three sides, excluding the other side surface side.

The main seat body A50 includes a flat base part A51, a seating part A52 which is provided on this base part A51, a back rest A53 which is attached to enable changing of its angle to the seating part A52, a head rest A54 which is provided on the top part of the back rest A53, and a pair of side arms A55 which are provided in positions on the seat surface of the seating part A52 and both sides of the back rest.

A card slot A72 for inserting a card is fitted and provided near the tip part of the side arm A55. In addition, the inside of the side arm A55 includes a card reader/writer A722 for reading data stored on a card and writing data to a card, a card holding part A724 for storing the card, a card transfer device A725 (FIG. 9A) flr transferring the card, and a card holding sensor A726 (FIG. 9A) for detecting that a card is stored and transmitting a holding completion signal.

The card has a storage medium for enabling data to be read and written, such as a magnetic card which stores data on a magnetic tape or an IC card which stores data on an IC chip embedded therein. In addition, data stored on the card can be personal information such as the player's user ID, gaming history, credit data which is used when starting the game, and the like. In addition, this credit data can be data indicating gaming rights purchased beforehand, such as in a prepaid system. Furthermore, the card can be a so-called credit card in which the number of times a game is played and the amount of time played are stored as credit data and charged after the passing of a predetermined period of time.

The seating part A52 moves back and forth on the base part A51 when the player operates the input operation part A72. In the main seat body A50, this seating part A52 can be slid back and forth and, at the same time, the back rest A53 can recline backwards and form a bed.

The seating part A52 includes a leg rest A521 which is provided on the front surface side and a foot rest A522 which is stored in the tip of this leg rest A521. The leg rest A521 turns upward according to the sliding motion, when the seating part A52 is slid forward, and becomes a seat surface which continues from the seat surface of the seating part A52. At the same time, the foot rest A522 projects from the leg rest A521 and becomes a seat surface which continues from the leg rest A521.

A bag component, into which air can be injected, is embedded respectively within the seat surface of the seating part A52, the lower part of the back rest A53 (which comes into contact with the lower back of the player) and the head rest A54. When air is injected into these bag components by an air pump, the surface swells and can support the user while accommodating the contours of the body surface of the user.

In addition, a seating sensor, which is not shown, is embedded in the seating part A52 or the back rest A53 for detecting that a player is seated. This seating sensor is a weight sensor or a pressure sensor which detects the load applied when the player is seated.

A sub-display part A61, which is configured to include a liquid crystal display panel, is stored in the side unit A60.

As shown in FIG. 2A, the sub-display part A61 includes a first support arm A611 which is supported by the side unit ASO, a second support arm A612 which is attached to the tip of the first support arm A611, and a flat, rectangular sub-monitor A613 which is attached to the tip of the second support arm A612 and performs liquid crystal display,

The first support arm A611 can be extended and retracted freely in the direction vertical to the side unit A60. The second support arm A612 can extend and retract freely and can be fixed to an arbitrary angle to the axis direction of the first support arm A611. The sub-monitor A613 can be fixed to an arbitrary angle to the axis direction of the second support arm A612.

A sub-monitor storage space A62 which extends in the vertical direction is provided in the side unit A60, and the foregoing first support arm A611, a second support arm A612, and a sub-monitor A613 are stored within the sub-monitor storage space A62.

A small CCD camera A614 is embedded into the sub-monitor A613. This CCD camera A614 is used when creating an avatar in the game field.

The image taken by the CCD camera A614 is displayed constantly in the sub-display part A61 in the terminal device A30, by operating an input operation part A72 (described hereafter). Because the expressions of the player per se can be viewed during the game in this way, enjoyment increases. In this case, the photographed image can be shown on the entire screen of the sub-monitor A613 or in one section of the screen.

The procedure by which the player pulls out the sub-monitor A613 from the storage space A62 is explained, with reference to FIG. 4A to FIG. 6A.

First, as shown in FIG. 4A, the player slides the sub-monitor A613 upward from the sub-monitor storage space A62 and extends the first support arm A611 and the second support arm A612, while seated in the main seat body A50. Then, as shown in FIG. 5A, the display screen of the sub-monitor A613 is turned toward the player by twisting the sub-monitor A613. Subsequently, as shown in FIG. 6A, the sub-monitor A613 is positioned to the player's eye level by adjusting the relative angles of the first support arm A611 and the second support arm A612 and the relative angles of the second support arm A612 and the sub-monitor A613.

Next, the connection part A615 between the first support arm A611 and the second support arm A612 and the connection part A616 between the second support arm A612 and the sub-monitor A613 are controlled by an electrically-controlled display fixation driving control device A63. Then, the sub-monitor A613 is fixed or released by the reception of a sub-display fixation signal or a sub-display fixation release signal (described hereafter) from the COU A91.

A sub-control device A90 which is connected by wireless LAN to the main control device A80 and a plurality of board storage slots A97 which configure this sub-control device A90 are provided within the side unit A60.

The sub-control device A90 controls the sub-display part A61 and the traveling part A32, based on instructions from the main control device A80, as well as transmitting signals input by the input operation part A72 (described hereafter) to the main control device A80.

A cover part A971 is provided to open and close freely on the upper part of the board storage slots A97. By opening the cover part A971 and inserting a terminal control board A972 from above, as shown in FIG. 2A, the terminal control board A972 can be attached to the board storage slot A97.

The back-side of the seat shell A70 extends upward and can support the back rest A53 and the head rest A54. In addition, speakers A75 and lamps A76 are provided on both sides of the head rest A54 of the seat shell A70.

The back-sides of the side surfaces of the seat shell A70 extends upward so that the player seated in the main seat body A50 cannot be viewed by other players.

The lamp A76 is provided on the tip of a rod-shaped support part attached to the side surface of the seat shell A70. This lamp A76 is provided at the highest position on the terminal device A30, which is a position which can be seen easily from outside of the terminal device A30.

This lamp A76 includes three types of LED chips which emit red, blue, and green light, and additionally, a reflective frame is provided surrounding these LED chips. The red, blue, and green lights emitted from each LED chip are blended by the reflective frame, and thus, in the present embodiment, the lamp A 76 illuminates with lighting aspects of six colors: purple, yellow, white, green, blue, and red.

A table A71 is attached from one side surface of the main seat body A50 to the front surface, on the upper edge of the seat shell A70. The space beneath this table A71 accepts the leg rest A521 and the foot rest A522 when the main seat body A50 is placed in bed mode.

The input operation part A72, configured by a keyboard, a jog dial and the like, is provided in the vicinity of the side arm A55 on the table A71.

Although the input operation part AB72 is provided on the table A71 in the present embodiment, this is not limited thereto, and can be provided as a touch-panel on the sub-monitor A613.

A medal payout opening A731 from which medals are paid out from a medal collection part A73 provided within the side unit A60, a medal receiving part A732 for receiving the medals which are paid out, and a medal insertion part A734 to which coins are inserted are provided below the table A71 and in front of the side arm A55. A reception opening for attaching a holder A733 is provided in the medal reception part A732. In addition, a sensor for detecting that a medal is inserted is installed in the medal insertion part A734. For example, this medal can be paid out according to the betting odds of an event within the game environment. For example; predetermined odds (betting odds) are stipulated to the participants for a certain event (win/loss of horse-racing, combat, etc.), similar to a book-maker, and the player bets on the object of his choice. Then, medals are paid out based on the odds, according to the win/loss results. The prize resulting from this book-maker is not limited to medals and can be items within the game environment.

FIG. 7A is a block diagram of an overall configuration of the game machine A1.

In this game machine A1, the main control device A80 of the main game machine body A20 had a wireless communication part A83 and the sub-control device A90 of the terminal device A30 has a wireless communication part A93. These wireless communication parts A83 and A93 can be interconnected by a wireless LAN, and thus, the transfer of sound data and character data can be performed between the main control device A80 and the sub-control device A90.

Configuration of the Main Control Device

FIG. 10A is a block diagram showing the configuration of the main control device A80.

The main control device A80 has a CPUA81, a memory A82, a wireless communication part A83, and a database A84, which are connected to a data bus A89.

The wireless communication part A83 includes a transceiving circuit part (RF) A85 for transmitting and receiving signals with the sub-control device A90, and a base band processing part A86 for converting RF (Radio Frequency) signals received by the transceiving circuit part A85 into base band signals and also converting base band signals to be transmitted into RF signals.

The database A84 is a circuit board which includes a memory part to which a game program is stored or a storage medium (for example, a hard disk or ROM cassette) to which the game program is stored.

Specifically, a slot to which these circuit boards and storage mediums can be attached and removed is provided in the main control device A80. By attaching and removing these circuit boards and storage mediums from the slot, the game program stored to the database A84 can be replaced, accordingly, and other game programs can be executed. Replacing the game program is not limited to that via hardware, as such, and the game program can be replaced directly by downloading via a communication circuit.

The CPU A81 executes various processing according to the game program.

In other words, the CPU A81 reads the game program stored in the database A84 to the memory A82 and runs the game according to this game program.

During the game, the CPU A81 extracts the game program, information expressing the game status corresponding to the time-line in the game field at that time (namely, information expressing events and the like occurring within the game field), scent data corresponding to the sub-area A212, and the like from the data base A84, in response to request from the terminal device A30, and transmits these to the terminal device A30, which is the request source, via wireless LAN. In addition, the CPU A81 receives information expressing the operation results of the player from each terminal device A30 and stores this in the memory A82.

The CPU A81 runs the game, based on the information expressing the operation results of the players stored in the memory A82, and stores the progression results of the game program in the database A84.

Here, the information expressing the operation results of the player are, for example, selection results by the player from a selection shown to the player via the terminal device A30, based on the progress of the game program, or the results of the operation performed by the player of the character appearing in the game, and is information transmitted from the terminal device A30 as a result of the player operating their respective terminal devices A30. Other players can check the progress status of the current game stored in this database A84 (for example, high-score information, etc.)

Configuration of the Sub-Control Device

FIG. 11A is a block diagram showing the configuration of the sub-control device A90.

The sub-control device A90 has a CPU A91, a memory A92, a wireless communication part A93, and an input and output part A94 which is the interface with the speaker A75, which are connected to a data bus A99.

The wireless communication part A93 includes a transceiving circuit part (RF) A95 for transmitting and receiving signals with the main control device A80, and a base band processing part A96 for converting RF (Radio Frequency) signals received by the transceiving circuit part A95 into base band signals and also converting base band signals to be transmitted into RF signals.

In addition, the sub-control device A90 controls the sub-display part A61, the driving control device A322, the direction control device A323, the card slot A721, the time measurement part A98, the display part fixation driving control device A63, and the input and output part A94 which is the interface with the speaker A75, based on the input signals from the input operation part A72, the CCD camera A614, and the IC tag detection part A324.

The CPU A91 executes various operations according to the operation programs stored in the memory A92 and control respective circuit parts and devices according to the operations.

Sound signals from the main control device A80 are output from the speaker A75 through the following procedure.

When the RF signal is received from the main control device A80, the transceiving circuit part A95 supplies this signal to the base band processing part A96 and converts this RF signal to a base band signal. The base band processing part A96 outputs this base band signal to the speaker A75, via the input and output part A94. Then, this base band signal is output from the speaker A75 as sound.

In addition, the CPU A91 transmits a sound signal to the input and output part A94 and outputs this from the speaker A75, when a card is inserted into the card slot A721 and the seating sensor installed in the seating part A52 or the back rest A53 does not detect seating.

Furthermore, when the player operates the input operation part A72, after converting various information input by operating the input operation part A72 into packet data, the CPU A91 transmits this to the main control device, via the band base processing part A96 and the transceiving circuit part A95. At this time, each terminal device A30 can be identified regardless of the position the terminal devices A30 are placed on the play area A21.

Similarly, the CPU A91 converts positional information read from the IC tag A211 by the IC tag detection part A324 and image information perceived by the CCD camera A614 into packet data and transmits this to the main control device A80.

On the other hand, when an RF signal to which information converted into packet data is superimposed is transmitted from the main control device A80, the CPU A91 receives this RF signal via the transceiving circuit part A95 and the base band processing part A96, displays it in the sub-display part A61 and, in addition, controls the driving control device A322 and the direction control device A323 of the traveling part A32.

In this way, the player seated in the terminal device A30 can communicate various information with the main control device A80.

Specifically, the CPU A91 performs the following operations.

In other words, when the CPU A91 receives the game program and information expressing the game status corresponding to the time-line in the game field at that time from the main control device A80, the CPU A91 shows various occurrences, such as events, occurring in the game field at this time according to the game program, after storing the information, such as the game program, transmitted from the main control device A89 in the memory A82.

Furthermore, the CPU A91 can always confirm the current position of the terminal device A30 within the play area A21 by reading the positional information from the IC tag A211 by the IC tag detection part A324. Then, the CPU A91 receives specification of the position on the play area A21 from the main control device, controls the driving control device A322 and the direction control device A323 of the traveling part A32 based on the signal from the IC tag detection part A324, and moves the terminal device A30 to a predetermined position within the play area A21.

In addition, by operating the input operation part A72 while viewing the game content (image, letter information, etc.) shown in the sub-display part A61, the player using respective terminal device A30 can operate the characters shown in the main display device A22, participate in the progress of the game by operations such as selecting from a selection by letters, and move the terminal device A30 to an designated position on the play area A21.

FIG. 10A is a main flowchart in which a card is detected and notification is given in an example of a preferred embodiment of the present invention.

In step SA100, the seating sensor installed in the seating part A52 and/or the back rest A53 detects seating, if seating is detected, the sensor transmits a signal to the CPU A91. In the seating sensor does not detect seating, the game machine stands by until seating is detected.

In step SA105, the card sensor A723 detects whether a card is inserted into card slot A721. If a card is not detected, the process returns to the processing in step SA100. If a card is detected, the card reader/writer A722 reads the data stored on the card (step SA110).

In step SA115, game start is determined. Specifically, the game is started when the CPU A91 transmits a game start signal to the main control device A80. If the game is not started, the process proceeds to step SA125.

In step SA120, whether to complete the game is determined. Specifically, for example, the game is completed when, in an operation within the game, a selection stating game completion is input from the input operation part A72 and received by the CPU A91. If the CPU A91 receives the game completion selection, the CPU 91 transmits a game completion signal to the main control device A80. If the game is not completed, the game is continued until a game completion selection is received.

In step SA125, seating is detected. Specifically, for example, the seating sensor installed in the seating part A52 and/or the back rest A53 detects seating of the player. If the seating sensor detects the seating of the player, the process returns to step SA 115. In addition, if the seating sensor does not detect seating, the process proceeds to the processing in step SA130 (FIG. 11A). In this way, whether the player has left the seat after completion of the game can be determined.

In step SA130, whether a card is inserted in the card slot SA721 is determined. When the card sensor A723 installed in the card slot A721 detects the card, the card sensor A723 transmits a signal to the CPU A91 and the CPU A91 transmits a first notification start signal (step SA135). If the card sensor A723 does not detect a card, the processing of the present flowchart is terminated. In other words, the card has been removed from the card slot A721.

In step SA140, a first notification is performed. This processing is described hereafter. This processing is performed by the input and output part A94 via the sub-display part A61, which received the first notification start signal from the CPU A91, and the speaker A75. Then, if this processing is completed, the process proceeds to the processing in step SA145.

In step SA145, a time measurement/card detection processing is performed. This processing is described hereafter. This time measurement/card detection processing measures time from the first notification and detects whether the card has been removed from the card slot A721 within a predetermined amount of time. In addition, this time measurement/card detection processing can be started almost simultaneously with the start of the first notification (step SA140).

In step SA150, the CPU A91 transmits a second notification start signal. In the stop SA145, when the insertion of a card in the card slot A721 is detected after the passage of a predetermined amount of time, the CPU A91 transmits a second notification start signal.

In step SA155, a second notification processing is performed. This processing is described hereafter. The second notification processing is performed by the input and output part A94, which received the second notification start signal from the CPU A91 in step SA150, via the speaker A75 and the lamp A76.

Although the second notification is performed by the speaker A75 and the lamp A76 in the present embodiment, it can be performed by either one, and furthermore, a message or the like can be displayed in the sub-display part A61 or the staff can be notified by radio or the like.

In step SA160, the same time measurement/card detection processing as in step SA145 is performed. Specifically, for example, the time from the second notification is measured and whether the card has been removed from the card slot A721 within the predetermined amount of time is detected. In addition, this time measurement/card detection processing can be started almost simultaneously with the start of the second notification (step SA155). When this processing is completed, the process proceeds to the processing in step SA165.

In step SA165, a card holding processing is performed. Specifically, for example, if the time from the second notification (step SA155) is measured and a card is detected in the card slot A721 by the card sensor A723 after the passage of a predetermined amount of time, the card is temporarily pulled within the card slot A721, and a card holding part A724 installed in the card slot A721 holds the pulled-in card. If this processing is completed, the process proceeds to the processing in step SA170.

In step SA170, notification is performed. For example, if the card holding part A724 holds the card, the card holding part A724 transmits a card holding signal to the CPU A91, and the CPU A91 which received this signal transmits a notification start signal to the input and output part A94. Then, the input and output part A94 which received the notification start signal illuminates the lamp A76. This illumination can be an aspect differing from the illumination of the notification performed in the second notification processing (step SA155). For example, it can be a color differing from that of the second notification or have a differing flashing pattern such as flashing three times consecutively.

In this way, the card can be pulled in and temporarily secured even if the player forgets the card and leaves the seat, and thus, theft of the card can be prevented, The held card is subsequently collected by the staff.

First Notification Processing

FIG. 12A is a flowchart of the first notification processing.

First, in step SA200, the card reader/writer A722, the sub-display part A61, and the input and output part A84 receive a first notification signal transmitted by the CPU A91.

In step SA205, the card readertwriter A722 starts reading the card data by the first notification start signal. Alternatively, the CPU A91 can read the data of the player stored temporarily in the memory A92. Then, the CPU A91 obtains the stored player name (step SA210). This player name can be the full name of the player or a name, such as a registration name, which is not limited to the user ID or the full name.

In step SA215, the CPU A91 shows the player name obtained in step SA210 and notification message in the sub-display part A61. This notification message can be text or can also be some sort of symbol or character, as well.

In step SA220, the CPU A91 sound outputs the player name obtained in step SA210 and predetermined notification message from the speaker A75, via the input and output part A94. This notification message is not limited to speech, and can be music or warning sounds. Although a sound volume which can only be heard by the player using the terminal device A30 is preferable when giving this first notification, it is not limited thereto and the volume can be raised.

This first notification is given to alert the player using the terminal device. In this way, the player can retrieve his card without other players knowing that he forgot the card.

Time Measurement/card Detection Processing

FIG. 13A is a flowchart showing the time measurement/card detection processing.

In step SA300, the time measurement part A98 starts to measure time. Then, whether the card is removed from the card slot A721 within the passage of a predetermined amount of time is determined (step SA305). Specifically, for example, whether the card sensor A723 detects the card is determined. If the card sensor A723 detects the card, the process proceeds to the processing in step SA310. If the card sensor A723 does not detect the card, the process returns to the flowchart in FIG. 12A and the processing is completed.

In step SA310, the CPU A91 determines whether a predetermined amount of time has passed. If the predetermined amount of time has not passed, the process returns to the processing in step SA305. If the predetermined amount of time has passed, the present sub-routine is completed, and the process proceeds to the processing in step SA150 or step SA165 in FIG. 11A.

Second Notification Processing

FIG. 14A is a flowchart showing the second notification processing.

In step SA400, the input and output part A94 receives the second notification start signal transmitted from the CPU A91. Then, the input and output part A94 illuminates the lamp A76 based on the signal received from the CPU A91 (step SA405). This illumination can be flashed at a predetermined interval, flashed in time with the sound output from the speaker A75, or the color thereof can be changed.

In step SA405, the input and output part A94 outputs the notification message by sound, through the speaker A75. This notification message is not limited to speech, and can be music or warning sounds. When this second notification is given, instances in which the player is not in the vicinity of the terminal device can be considered because time has passed since the first notification. Therefore, because the purpose is not only to notify the player using the terminal device A30 but also to notify and alert the staff, the sound volume is preferably loud. However, it is not limited thereto and can be low. When this processing is completed, the present sub-routine is completed and the process proceeds to the processing in step SA160 (FIG. 11A).

The flowchart in FIG. 15A is explained as another embodiment. FIG. 15A is a flowchart showing a processing for notifying the player that he has forgotten his card by fixing the sub-display partA61.

In step SA500, the CPU A91 determines whether the seating sensor installed in the seating part A53 and/or the back rest A53 of the seat part A31 detects seating. If seating is detected, the process proceeds to the processing in step SA505. If seating is not detected, the process stands by until the seating sensor detects seating.

In step SA505, the CPU A91 determines whether a card is inserted into card slot A721. Specifically, for example, this is determined by whether the card sensor S723, installed in the card slot A721, detects a card. If the card sensor A723 detects the card, the process proceeds to the processing in step SA510. If the card sensor A723 does not detect the card, the process returns to the processing in step SA500.

In step SA510, the start of a game is determined. Specifically, when a game is started, the CPU A91 transmits a game start signal to the main control device A80. Then, the game starts. If the game start signal is not transmitted, the game does not start. If the game is not started, the process proceeds to the processing in step SA520.

Whether the game is completed is determined in step SA515. Specifically, for example, a selection stating the completion of the game is entered in the input operation part A72, in the operation in the game, and received by the CPU A91. If the CPU A91 receives the game completion selection, the CPU A91 transmits a game completion signal to the main control device A80 and terminates the game. If the game is not completed, the game is continued until the game completion selection is received.

In step SA520, card detection is performed. The CPU A91 determines whether a card is inserted into the card slot A721. Specifically, for example, this is determined by whether the card sensor S723, installed in the card slot A721, detects a card. If the card sensor A723 detects the card, the process proceeds to the processing in step SA525. If the card sensor A723 does not detect the card, the process is completed.

In stop SA525, the CPU A91 transmits a sub-display fixation signal. This signal is for notifying that the card is inserted in the card slot A721 by fixing the sub-display part and getting in the way when the player attempts to stand. By this sub-display fixation signal, the connection parts A615 and A616 of the sub-display part A61 and a fixation part are fixed (step SA530). In addition, simultaneously with the fixation of the sub-display part A61, notification can be given by the sub-monitor A613 of the sub-display part A61, the speaker A75 and the lamp A76.

In stop SA535, the CPU A91 detects the card. Specifically, for example, whether the card sensor A723, installed in the card slot A721, detects the card, is determined. If the card sensor A723 detects the card, the process proceeds to the process in step SA530. If the card sensor A723 does not detect the card, the fixation of sub-display part A61 is released (step SA540) and the processing is completed.

Notification through fixation of the sub-display part can be performed as the first notification and/or the second notification in the main flowchart shown in FIG. 11A and FIG. 12A, as described in FIG. 16A.

In addition, the first notification and/or second notification and notification by the fixation of the sub-display part A61 can be performed simultaneously. In this case, the CPU A91 transmits a sub-display fixation signal when transmitting the first notification start signal. In addition, if the card is not detected (steps SA305 and SA535), the CPU A91 transmits the sub-display fixation release signal.

According to the present embodiment, the following effects can be obtained.

(1) Because notification is given when the card is in the card slot A721 regardless of the player leaving the seat, it is possible to prevent the card from being forgotten. Furthermore, because individual data of the player regarding the game and credit information are stored on the card, the game can be continued using this individual data. In addition, there are instances in which the player's sense of enjoyment can be continued by preventing the card from being left behind in this way.

(2) Because credit information is stored on the card, giving it so-called monetary value, the importance of the card to the player is increased, thus, encouraging players keep the card in mind so as to eliminate cards from getting left behind.

(3) If a card is in the card slot A721 regardless of the player leaving the seat, it is possible to prevent the card from being forgotten. Furthermore, because individual data of the player regarding the game and credit information are stored on the card, the game can be continued using this individual data. In addition, there are instances in which the player's sense of enjoyment can be continued by preventing the card from being left behind in this way.

(4) For example, first notification by sound from the speaker A75 and display in the sub-monitor A613 is performed. Then, if the card is still in the card slot A721 after the first notification, notification is given by sound from the speaker and light from the lamp A76. Thus, it is possible to prevent the card from being left behind by alerting the player again.

(5) Because the sub-monitor is fixed when the player attempts to leave his seat without removing the card when the game is completed, the display part can get in the way and prevent the player from leaving his seat. In this way. there are instances in which the player can realize that he has forgotten his card, thus, preventing the card from being left behind.

(6) If the player has left the card behind regardless of the notifications, the card can be held in the card holding part A724, after the passage of a predetermined amount of time. Therefore, even if the card has been left behind, it is held by the card holding part A724, and the possibility of theft by another person can be reduced.

(7) Because the terminal device A30 can move, a new sense of enjoyment can be provided to the player and the diminishing of enjoyment of the game can be prevented.

The preferred embodiments of the present invention are described below, with reference to the drawings.

Overall Configuration of the Game Machine

FIG. 1B is a perspective view showing an outward aspect of the game machine 1 according to an embodiment of the present invention.

The game machine 1 is a multi-player game machine, including a main game machine body B20 which includes a flat, rectangular play area B21 and a plurality of terminal devices B30 which are placed on this play area B21.

Aside from the play area B21, the main game machine body B20 includes a main display device B22 which is placed along one side of the play area B21, a speaker device B23 which is placed in the four corners of the play area B21, and a main control device B80 for controlling these main display device B22 and speaker device B23.

The play area B21 is divided into a plurality of sub-areas B212. As these sub-areas B212, there are city areas B212A, ocean areas B212B, and forest areas B212C. In addition, IC tags B211 are buried in grid-form in the play area B21. Positional information of the inside of the play area B21 is stored to this IC tag B211.

The main display device B22 is a large projector display device. The main display device B22 is not limited thereto and can also be a large monitor.

The main control device B80 can communicate with each terminal device B30 bi-directionally through wireless LAN and can provide each player with a common virtual space by executing the predetermined game program and bi-directionally communicating with each terminal device B30.

Each terminal device B30 is placed facing towards the main display device B22. This terminal device B30 is connected to the main control device B80 through wireless LAN and can be moved over the play area B21 according to the instructions from the main control device B80 or by player operation.

FIG. 2B is a perspective view showing an outward aspect of each terminal device B30.

The terminal device B30 includes a seat B31, a traveling part B32 which supports this seat B31 from beneath and, in addition, moves it over the player area B21, a hook B40 to which belongings are hung, and a belongings camera B42 for photographing the belongings hung on the hook B40.

Configuration of the Seat

FIG. 3B is a perspective view of the seat B31 The configuration is described hereafter, using FIG. 2B and FIG. 3B.

Seat B31 includes a main seat body B50 (FIG. 3B), a side unit 660 (FIG. 3B) which is provided along one side surface of the main seat body B50, and a seat shell B70 (FIG. 3B) which surrounds the main seat body B50 on three sides, excluding the other side surface side.

The main seat body B50 includes a flat base part B51 (FIG. 2B), a seating part B52 (FIG. 3B) which is provided on this base part B51, a back rest B53 (FIG. 3B) which is attached to enable changing of its angle to the seating part B52, a head rest B54 (FIG. 3B) which is provided on the top part of the back rest B53, and a pair of side arms B55 (FIG. 38) which are provided in positions on the seat surface of the seating part B52 and both sides of the back rest B53.

The seating part B52 moves back and forth on the base part B51 when the player operates the input operation part B72 (FIG. 2B). In the main seat body B50, this seating part B52 can be slid back and forth and, at the same time, the back rest BS3 can recline backwards and form a bed.

The seating part 852 includes a leg rest B521 (FIG. 3B) which is provided on the front surface side and a foot rest B522 (FIG. 3B) which is stored in the tip of this leg rest B521. The leg rest 8521 turns upward according to the sliding motion, when the seating part B52 is slid forward, and becomes a seat surface which continues from the seat surface of the seating part B52. At the same time, the foot rest B522 projects from the leg rest B521 and becomes a seat surface which continues from the leg rest B521.

A bag component, into which air can be injected, is embedded respectively within the seat surface of the seating part B52, the lower part of the back rest B53 (which comes into contact with the lower back of the player) and the head rest BE4. When air is injected into these bag components by an air pump, the surface swells and can support the user while accommodating the contours of the body surface of the user.

In addition, a seating sensor, not shown, for detecting that a player is seated is embedded in the seating part B52 or the back rest B53. This seating sensor is a weight sensor or a pressure sensor which detects the pressure applied when a player is seated. When the seating sensor detects seating, a lock start signal for operating the hook B40 is transmitted. If seating is not detected, a lock release signal is transmitted.

The sub-display part B61 (FIG. 28 and FIG. 3B) which is configured to include a liquid crystal display panel is stored in the side unit B60.

As shown in FIG. 2B, the sub-display part B61 includes a first support arm B611 which is supported by the side unit B60, a second support arm B612 which is attached to the tip of the first support arm B611, and a flat, rectangular sub-monitor B613 which is attached to the tip of the second support arm B612 and performs liquid crystal display.

The first support arm B611 can be extended and retracted freely in the direction vertical to the side unit B60. The second support arm B612 can extend and retract freely and can be fixed to an arbitrary angle to the axis direction of the first support arm B611. The sub-monitor B613 can be fixed to an arbitrary angle to the axis direction of the second support arm B612.

A small CCD camera B614 is embedded into the sub-monitor B613. This CCD camera B614 is used when creating an avatar in the game field. The image taken by the CCD camera B614 is displayed constantly in the sub-display part B61 in the terminal device B30, by operating an input operation part B72 (described hereafter). Because the expressions of the player per se can be viewed during the game in this way, enjoyment increases. In this case, the photographed image can be shown on the entire screen of the sub-monitor B613 or in one section of the screen.

A sub-monitor storage space B62 which extends in the vertical direction is provided in the side unit B60, and the foregoing first support arm B611, a second support arm B612, and a sub-monitor B613 are stored within the sub-monitor storage space B62.

A sub-control device B90 which is connected by wireless LAN to the main control device B80 and a plurality of board storage slots B97 which configure this sub-control device B90 are provided within the side unit B60.

The sub-control device B90 controls the sub-display part B61 and the traveling part B32, based on instructions from the main control device B80, as well as transmitting signals input by the input operation part B72 (described hereafter) to the main control device B80.

A cover part B971 is provided to open and close freely on the upper part of the board storage slots B97. By opening the cover part B971 and inserting a terminal control board B972 from above, as shown in FIG. 2B, the terminal control board B972 can be attached to the board storage slot B97.

The back-side of the seat shell B70 extends upward and can support the back rest B53 and the head rest B54. In addition, speakers B75 are provided on both sides of the head rest B54 of the seat shell B70.

The back-sides of the side surfaces of the seat shell B70 extends upward so that the player seated in the main seat body B50 cannot be viewed by other players.

A table B71 (FIG. 2B) is attached from one side surface of the main seat body B50 to the front surface, on the upper edge of the seat shell B70. The space beneath this table B71 accepts the leg rest B521 and the foot rest B522 which is provided by rotating a part of the leg rest B521.

The input operation part B72 (FIG. 2B), configured by a keyboard, a jog dial and the like, is provided in the vicinity of the side arm B55 on the table B71. A card slot B721 for inserting credit cards and membership cards is provided and a sensor, not shown, for detecting the insertion of the card is installed in this input operation part B72.

Although the input operation part B72 is provided on the table B71 in the present embodiment, this is not limited thereto, and can be provided as a touch-panel on the sub monitor B613.

A medal payout opening B731 from which medals are paid out from a medal collection part B73 provided within the side unit B60, a medal receiving part B732 for receiving the medals which are paid out, and a medal insertion part B734 to which medals are inserted are provided below the table B71 and in front of the side arm B55. A holder B733 for attaching the medal receiving part B732 is provided in the medal reception part A732, in addition, a sensor for detecting that a medal is inserted is installed in the medal insertion part A734. For example, this medal can be paid out according to the betting odds of an event within the game program, For example, predetermined odds (betting odds) are stipulated to the participants for a certain event (win/loss of horse-racing, combat, etc.), similar to a book-maker, and the player bets on the object of his choice. Then, medals are paid out based on the odds, according to the win/loss results. The prize resulting from this book-maker is not limited to medals and can be items within the game environment.

A hook B40 (described hereafter) on which belongings are hung and a belongings camera B42 are provided on the outside of the seat shell B70. Although the hook B40A (FIG. 2B) is provided on the outside of the seat shell B70, this is not limited thereto, and can be provided below the table B71 (B40C; FIG. 3B) or on the back surface of the back rest B53 (B40B; FIG. 3B). In addition, the hook B40B is not limited to the back surface of the back rest B53 and can be provided on the lower part of the side arm B55. The hook B40 is not limited to one location and can also be provided in plural locations. A belongings holder B41 for placing belongings can also be provided below the hook B40.

In addition, a belongings camera B42 is provided above the hook B40. This belongings camera B42 faces the hook part below, and photography starts when a stopper B413, described hereafter extends and the upper aperture of the hook enters a closed state. In other words, when the CPU B91 transmits a lock start signal to the hook, a photography start signal is transmitted to the belongings camera simultaneously, and the belongings camera B42 receives the photography start signal and starts photography. The photographed images are shown on the sub-monitor B613. This image can be shown constantly on the sub-monitor or shown by operation of the input operation part B72 by the player. In this case, the photographed image can be shown on the entire screen of the sub-monitor or shown in one part of the screen.

FIG. 4B and FIG. 5B are enlarged perspective views of the hook B40. The hook P40 includes a main hook body B411, a hook control device B412 for receiving lock start signals and lock release signals, described hereafter and extending a stopper, a stopper B413 which is configured by an electric actuator (not shown), a stopper storage part B414 in which the electric actuator is stored, and a lamp B416. In addition, a sensor B415 is provided in the balancing support part B417 of the main hook body B411.

Specifically, if some kind of a load, such as belongings being hung, is applied to the balancing support part B417 of the main hook body B411, the sensor B415 detects that a load is applied and transmits a lock start signal to the hook control device B412. The hook control device B412 which receives the signal drives the motor of the electric actuator to extend the stopper B413, and extends the stopper B413 from the stopper opening B418, as in FIG. 6B. The lock signal is not limited to detection by the sensor B415 and can also be transmitted by detection by the seating sensor embedded in the seating part B52 or the back rest B53 or detection of the transmission of the game start signal from the CPU B91 to the main control device B80.

The sensor B415 can be a weight sensor which detects weight, but is not limited to weight, and can be a touch sensor for detecting that the belongings are touching the sensor or a so-called presence detection sensor, such as an infrared sensor or a light sensor.

In addition, the contact part B419 of the balancing support part B417 which is in contact with the stopper B413 has a concave cavity-shape in order to fit the tip part of the stopper B413. The tip part of the stopper B413 fits into this depression. Then, when the stopper B413 is extended, a lamp B416, which is provided outside of the balancing support part B417 is lit.

Furthermore, by receiving a lock start signal from the CPU B91, the electric actuator for extending the stopper B413 is locked and the stopper B413 is fixed.

The stopper B413 is can be fixed when the sensor B415 detects the belongings, transmits the lock start signal, and the hook control device B412 receives the signal or simultaneously with the stopper B413 extending and coming into contact with the contact part B419.

In addition, in order to release the lock, the hook control device B412 receives a lock release signal from the CPU B91. In this way, the fixation of the stopper B413 can be released, and when the lock release signal is received by the hook control device B412 again, the electric actuator can operate to store the stopper B413 into the stopper storage part B414 and the hook B40 can enter an opened state. The fixation of the stopper B413 can also be released and the stopper B413 can be stored with the reception of one lock release signal.

As shown in FIG. 7B, the risk of theft of the hung belongings can be circumvented by extending and fixing the stopper B413.

FIG. 8B is a block diagram of an overall configuration of the game machine B1.

In this game machine B1, the main control device B80 of the main game machine body B20 had a wireless communication part B83 and the sub-control device B90 of the terminal device B30 has a wireless communication part B93, These wireless communication parts B83 and B93 can be interconnected by a wireless LAN, and thus, the transfer of sound data and character data can be performed between the main control device B80 and the sub-control device B90

Configuration of the Main Control Device

FIG. 9B is a block diagram showing the configuration of the main control device B80.

The main control device B80 has a CPU B81, a memory B82, a wireless communication part B83, and a database B84, which are connected to a data bus B89.

The wireless communication part B83 includes a transceiving circuit part (RF) B85 for transmitting and receiving signals with the sub-control device B90, and a base band processing part B86 for converting RF (Radio Frequency) signals received by the transceiving circuit part B85 into bass band signals and also converting base band signals to be transmitted into RF signals.

The database B84 is a circuit board which includes a memory part to which a game program is stored or a storage medium (for example, a hard disk or ROM cassette) to which the game program is stored.

Specifically, a slot to which these circuit boards and storage mediums can be attached and removed is provided in the main control device B80. By attaching and removing these circuit boards and storage mediums from the slot, the game program stored to the database B84 can be replaced, accordingly, and other game programs can be executed. Replacing the game program is not limited to that via hardware, as such, and the game program can be replaced directly by downloading via a communication circuit.

The CPU B81 performs various processing according to the game program.

In other words, the CPU B81 reads the game program stored in the database B84 and runs the game according to this game program.

During the game, the CPU B81 extracts the game program, information expressing the game status corresponding to the time-line in the game field at the time (namely, information expressing events and the like occurring in the game field) from the database B84 and transmits this to the terminal device B30, which is the request source, via wireless LAN. In addition, the CPU B81 receives information expressing the operation results of the player from each terminal device B30 and stores this in the memory B82, via wireless LAN.

The CPU B81 runs the game and stores the progress results of the game program to the database B84, based on the information expressing the operation results of the player stored to the memory B82.

Here, the information expressing the operation results of the player are, for example, selection results by the player from a selection shown to the player via the terminal device B30, based on the progress of the game program, or the results of the operation performed by the player of the character appearing in the game, and is information transmitted from the terminal device B30 as a result of the player operating their respective terminal devices A30. Other players can check the progress status of the current game stored in this database A84 (for example, high-score information, etc.)

Configuration of the Sub-Control Device

FIG. 10B is a block diagram showing the configuration of the sub-control device B90.

The sub-control device B90 has a CPU B91, a memory B92, a wireless communication part B93, and an input and output part B94 which is the interface with the speaker B75, which are connected to a data bus B99.

The wireless communication part B93 includes a transceiving circuit part (RF) B95 for transmitting and receiving signals with the main control device B80, and a base band processing part B96 for converting RF (Radio Frequency) signals received by the transceiving circuit part B95 into base band signals and also converting base band signals to be transmitted into RF signals.

In addition, the sub-control device B90 controls the sub-display part B61, driving control device B322, and direction control device B323, based on the input signals from the input operation part B72, medal insertion part B734, hook B40, CCD camera B73, belongings camera B42, timer B98, card slot B721, and IC tag detection part B324.

The CPU B91 executes various operations according to the operation programs stored in the memory B92 and control respective circuit parts and devices according to the operations.

Sound signals from the main control device B80 are output from the speaker B75 through the following procedure.

When the RF signal is received from the main control device B80, the transceiving circuit part B95 supplies this signal to the base band processing part B96 and converts this RF signal to a base band signal. The base band processing part B96 outputs this base band signal to the speaker B75, via the input and output part B94. Then, this base band signal is output from the speaker B75 as sound.

Furthermore, when the player operates the input operation part B72, after converting various information (text information, specific selection information, etc.) input by operating the input operation part B72 into packet data, the CPU B91 transmits this to the main control device B80, via the band base processing part B96 and the transceiving circuit part B95. At this time, each terminal device B30 can be identified regardless of the position the terminal devices B30 are placed on the play area B21.

Similarly, the CPU B91 converts positional information read from the IC tag B211 by the IC tag detection part B324 and image information perceived by the CCD camera B73 into packet data and transmits this to the main control device B80.

On the other hand, when an RF signal to which information converted into packet data is superimposed is transmitted from the main control device B80, the CPU B91 receives this RF signal via the transceiving circuit part B95 and the base band processing part B96, displays it in the sub-display part B61 and, in addition, controls the driving control device B322 and the direction control device B323 of the traveling part B32.

In this way, the player seated in the terminal device B30 can communicate various information with the main control device B80.

Specifically, the CPU B91 performs the following operations.

In other words, when the CPU B91 receives the game program and information expressing the game status corresponding to the time-line in the game field at that time from the main control device B80, various occurrences, such as events, occurring in the game field at this time is shown in the main display device B22, according to the game program, after storing the information, such as the game program, transmitted from the main control device B89 in the memory B82.

Furthermore, the CPU B91 can always confirm the current position of the terminal device B30 within the play area B21 by reading the positional information from the IC tag B211 by the IC tag detection part B324, Then, the CPU B91 receives specification of the position on the play area B21 from the main control device, controls the driving control device B322 and the direction control device B323 of the traveling part B32 based on the signal from the IC tag detection part B324, and moves the terminal device B30 to a predetermined position within the play area B21.

In addition, by operating the input operation part B72 while viewing the game content (image, letter information, etc.) shown in the sub-display part B61, the player using respective terminal device B30 can operate the characters shown in the main display device B22, participate in the progress of the game by operations such as selecting from a selection by letters, and move the terminal device B30 to an designated position on the play area B21.

Lock Start Processing

FIG. 11B is a flowchart of a processing for starting the lock of the hook B41 in one example of a preferred embodiment of the present invention.

First, the CPU B91 determines the availability of belongings detection, game medium insertion detection, seating detection or game start detection (step SB100). The belonging detection is performed by the sensor B415. This sensor B415 can be a weight sensor or a so-called presence detection sensor, such as a touch sensor. In addition, the game medium insertion detection is performed by a sensor installed in the card slot B721 or a sensor installed in the medal insertion part B734. In addition, the seating detection is performed by a seating sensor, and the game start is detected by the CPU B91 transmitting a game start signal to the main control device B80. If these are not detected, the game machine stands by until they are detected.

When belongings, game medium, seating, or game start is detected, the CPU B91 transmits a lock start signal to the hook control device B412 (step SB105). The hook control device B412 which receives the look start signal drives the electric actuator within the stopper storage part B414 and extends the stopper B413 (step SB110). When the stopper B413 contacts the contact part B418, the electric actuator can be looked and the stopper B413 can be fixed.

In step SB115, confirmation display is performed in the sub-monitor B613. For example, a display such as “Do you want to lock the hook?” is performed. This confirmation can be changed to the sub-monitor B613 or can be both through both display and sound, as well,

In step SB120, the CPU B91 determines whether to lock the hook. This determination is made by showing selection choices when showing the confirmation display in step SB115 and the player selecting a selection choice via the input operation part B72. If the CPU 91 receives an input of the selection choice, “Do not lock”, the process proceeds to the processing in step SB122. In addition, if an input of the selection choice “Lock” is received, the process proceeds to the processing in step SB130.

In step SB122, the CPU 91 determines whether the sensor B41 detects belongings. If the sensor B415 detects belongings, the process returns to step SB115. In addition, if the sensor B415 does not detect belongings, the sensor B415 transmits a lock release signal (step SB124) and the hook control device B412 returns the stopper to its original state (step SB126). This is an instance, for example, when the belongings are hung on the hook B40 once but then are lifted up to be removed from the hook in order to move to another seat or the like.

In step SB120, when the CPU B91 receives input for performing lock from the input operation part or the like by the player, the CPU B91 transmits a lock start signal to the hook control device B412 (step SB130). Then, the hook control device B412 locks the electric actuator and locks the stopper B413 (step SB140). When this processing is completed, the present flowchart is completed.

Lock Release Processing

FIG. 12B is a flowchart of a processing for releasing the lock of the hook B40, in one example of a preferred embodiment of the present invention.

First, in step SB200, it is determined whether the game is completed or the player has left the seat. Specifically, the game is completed when the CPU B91 transmits a game completion signal to the main control device B80, and the player has left the seat when the seating sensor embedded in the seating part B52 or the back rest B53 of the main seat body B50 does not detect seating. Then, if the sensor B415 does not detect game completion or leaving of the seat, the game machines stands by until it is detected. In addition, when the game completion or leaving of the seat is detected, the process proceeds to the processing in step SB205.

In step SB206, the lock release signal is transmitted. The CPU B91 transmits the lock release signal when the CPU B91 transmits a game completion signal to the main control device B80 in step SB200. In addition, if the seating sensor does not detect seating, the seating sensor transmits a lock release signal.

In step SB202, the timer B98 starts to measure time. Then, in step SB210, lock release notification is performed. Specifically, the CPU B91, which received the lock release signal transmitted in step SB205, displays message, symbols, and the like stating that the lock has been released on the sub-monitor B613. In addition, the hook control device B412 which received the lock release signal flashes the lamp B416 of the hook B40. This notification can be given by sound via the speaker B75 by instruction sent from the CPU B91 to the input and output part B94.

In step B212, the CPU B91 determines whether a predetermined amount of time has passed. Specifically, whether the time measured by the timer B98 in step SB202 has exceeded a predetermined amount of time is determined, This predetermined amount of time can, for example, be set beforehand, presuming the time until player reaches the hook B40 from the detection of the player leaving the seat or the game completion. If it is determined that the predetermined amount of time has not passed, the process returns to the processing in step SB210. If it is determined that the predetermined amount of time has passed, the process proceeds to the processing in step SB215.

Then, the CPU B91 transmits the lock release signal to the hook control device B412, and the hook control device B412 releases the lock of the stopper B413 (step SB215). Furthermore, if the sensor B415 does not detect the belongings because the player has lifted up the belongings or the like, the sensor B415 transmits a lock release signal (step SB225), and the hook control device B412 opens the stopper (step SB230). Although the lock of the stopper B413 is released in stop SB215 and the stopper B413 is opened in step SB230, the stopper B413 can be opened when the lock is released, as well.

In addition, although the hook B40 is provided on the outside of the seat shell B70, the back surface of the back rest B53 of the main seat body B50, or under the table B71, when storing the belongings, it is not limited thereto.

In addition, as another embodiment, rather than the game machine B1 being configured by the main game machine B20 and the terminal device B30, it can be configured so that the game can be played by the terminal device alone. In this case, in the configuration of the sub-control device B90 (FIG. 10B), a database for storing the game program and memory are included, as in the main control device B80. Furthermore, the CPU B91 reads the game program stored in the database to the memory, displays image in the sub-display part B61 according to the game program and runs the game. Then, the hook control device B412 can extend and retract the stopper B413 of the hook B40 according to the game start signals and the game completion signals transmitted by the CPU B91 and perform lock and lock release.

According to the present embodiment, the following effects are attained.

(1) The hook B40, which is normally in an unlocked state, enters a locked state when a game start signal is received from the control B90 and moves to an unlocked state when a game completion signal is received. In this way, because a key or the like for locking the hook B40 is not required, the player can concentrate on the game without thinking about the whereabouts of the key or theft of his belongings, and the player's sense of enjoyment can be enhanced.

(2) Because a hook B40B is provide for hanging the belongings on the back surface of the main seat body B50 of the terminal device B30, and the hook B40 locks when the player hangs his belongings on the hook B40B, the risk theft of belonging during a game can be reduced. In this way, because this operation is performed automatically the player does not have to lock the hook manually and a game machine B1 which enable a reduced risk of theft of belongings can be provided.

(3) The stopper B413 of the hook B40 is extended according to the seating of the player in seat B31, and the hook B40 can be locked. Because the hook B40 can be locked automatically when the player sits, the player does not have to lock the hook manually and a game machine B1 which enables a reduced risk of theft of belongings can be provided.

(4) The lock of the stopper B413 of the hook B40 can be released by transmitting a lock release signal according to when the player left the seat. Then, because the player does not have to lock the hook manually, a key or the like for locking the hook B40 is not required, and the player is freed from the management of a key, a game machine B1 which enables the player to concentrate further and enjoy the game more can be provided.

(5) Because the lock of the hook B40 is released after a predetermined amount of time has passed from when the player left his seat, the hook B40 can remain in a locked state from when the player leaves his seat until he reaches the location of the hook B40. Thus, theft of the belongings until the player reaches the location of the hook B40, due to the lock being released immediately after the player leaves his seat, can be prevented.

(6) Because the hook B40A is attached to not only the main body of the terminal device B30, but also the outside of the seat shell B70, covering the terminal device B30, the belongings do not have to be placed within the seat shell B70. In this way, the belongings do not get in the way of the game, and a game machine B1 which enables the provision of an environment enabling the player to concentrate on the game further can be provided.

(7) Because a belongings camera photographs an image of the object-to-be-hung when the upper aperture of the hook B40 is in a closed state, and this image is shown in the display part, the player can check the state of his belongings at any time. Thus, the fear of the theft of belongings can be reduced. In addition, a game machine B1 which enables the provision of an environment enabling the player to concentrate on the game further and which enhances the sense of enjoyment of the player can be provided.

(8) Because a lockable hook B40 is attached to a mobile terminal device B30, a game can be played without the belongings getting thrown down, even when the terminal device moves. In this way, because the risk of theft due to the belongings getting thrown down is reduced, a game machine B1 which enables the player to concentrate on the game further and which enhances the sense of enjoyment of the player can be provided.

The game machine of the present embodiment is described hereafter.

FIG. 1C is a perspective view showing an outward aspect of the game machine C1 according to an embodiment of the present invention.

The game machine C1 is a multi-player game machine, in which multiple players participate, including a main game machine body C20 which includes a flat, rectangular play area C21 and a plurality of terminal devices C30 which are placed on this play area C21.

Aside from the play area 021, the main game machine body C20 includes a main display device C22 which is placed along one side of the play area C21, a speaker device C23 which is placed in the four comers of the play area C21, and a main control device C80 for controlling these main display device C22 and speaker device C23.

The play area C21 is divided into a plurality of sub-areas C212. As these sub-areas C212, there are city areas C212A, ocean areas C212B, and forest areas C212C. In addition, IC tags C211 are buried in grid-form in the play area C21. Positional information of the inside of the play area C21 is stored to this IC tag A211.

The main display device A22 is a large projector display device. Although a large projector display device is implemented in the present embodiment, it is not limited thereto in the present invention and can be a large monitor.

The main control device C80 can communicate with each terminal device C30 bi-directionally through wireless LAN and can provide each player with a common virtual space by executing the predetermined game program and bi-directionally communicating with each terminal device C30.

Configuration of the Terminal Device

FIG. 2C is a perspective view showing an outward aspect of each terminal device C30.

The terminal device C30 includes a seat C31, a main terminal device body C30A, a liquid crystal display device C61, and a traveling part C32 which is provided beneath the main terminal device body C30A and moves the terminal device C30 over the player area C21.

The terminal device C30 is placed in a state facing the main display device C22. This terminal device C30 is connected to the main control device C80 by wireless LAN and can be moved over the player area C21 in adherence to instructions from the main control device C80 or operations by the player.

The main terminal device body C30A includes a seat C50, a side unit C60 which is provided along one side surface of the seat C50, and a seat shell C70 which is attached behind the seat C50 and in front of the seat C50, an input operation part C72 for receiving input from the player, and a medal collection part C83 including a medal insertion part C74 to which medals are inserted and the like.

FIG. 3C is a perspective view of the main terminal device body C30A in seat mode. FIG. 4C is a perspective view of the main terminal device body C30A in bed mode.

As shown in FIG. 3C and FIG. 4C, the seat C50 can be adjusted to seat mode and bed mode and the gradient of the seat can be adjusted in multiple steps, between the seat mode and the bed mode, as well.

The seat C50 includes a flat base part C51, a seating part C52 which is provided on this base part C51, a back rest C53 which is attached to enable changing of its angle to the seating part C52, a head rest C54 which is provided on the top part of the back rest C53, and a pair of side arms C55 which are provided in positions on the seat surface of the seating part 52 and both sides of the back rest.

The seating part C52 moves back and forth on the base part C51 when the player operates the input operation part C72. The main seat body C50 changes from the seat mode shown in FIG. 3C to the bed mode shown in FIG. 4C, when this seating part C52 is slid forward, and forms a bed.

The seating part 052 includes a leg rest C521 which is provided on the front surface side and a foot rest C522 which is stored in the tip of this leg rest C521. The leg rest C521 turns upward according to the sliding motion, when the seating part C52 is slid forward, and becomes a seat surface which continues from the seat surface of the seating part C52. At the same time, the foot rest C522 projects from the leg rest C521 and becomes a seat surface which continues from the leg rest C521.

The back rest C53 falls backward, according to the back and forth movement of the seat part C52 on the base part C51.

The front surface side of the side arm C55 turns slightly upward, when the main seat body C51 is placed in bed mode.

A bag component, into which air can be injected, is embedded respectively within the seat surface of the seating part 5C2, the lower part of the back rest C53 (which comes into contact with the lower back of the player) and the head rest C54. When air is injected into these bag components by an air pump, the surface swells and can support the user while accommodating the contours of the body surface of the user.

A liquid crystal-monitor storage space C62 which extends in the vertical direction is provided in the side unit A60, and the foregoing first support arm A611. a second support arm A612, and a liquid crystal monitor A613 are stored within the liquid crystal monitor storage space A62.

A sub-control device C90 which is connected by wireless LAN to the main control device C80 and a plurality of board storage slots C97 which configure this sub-control device C90 are provided within the side unit C60.

The sub-control device CGO controls the transmitting part C64 for transmitting game images to the liquid crystal display device C61, a liquid crystal monitor driving control device C63 for driving the liquid crystal display device C61, and the traveling part C32, based on instructions from the main control device A80, as well as transmitting signals input by the input operation part C72 (described hereafter) to the main control device C80. The transmission of game image from the transmitting part C64 to the liquid crystal display device C61 can be by a wired or wireless connection.

A cover part C97A is provided to open and close freely on the upper part of the board storage slots C97. By opening the cover part C97A and inserting a terminal control board C97B from above, as shown in FIG. 2C, the terminal control board C97B can be attached to the board storage slot C97.

The back-sides of the side surfaces of the seat shell C70 extends upward, such that the player seated in the main seat body C50 cannot be viewed by other players. In addition, the seat shell C70 can support the back rest C53 and the head rest CM. Furthermore, speakers C75 are provided on both sides of the head rest C54 of the seat shell C70.

A table C71 is attached from one side surface of the seat C50 to the front surface, on the upper edge of the seat shell C70. The space beneath this table C71 accepts the leg rest C521 and the foot rest C52 when the seat C50 is placed in bed mode.

The input operation part C72 is provided in the vicinity of the side arm C55 on the table C71, or in other words, a position wherein the player can perform operations while seated in the seat C50, and includes a keyboard, a jog dial and the like. A card slot C72A for inserting credit cards and membership cards is provided in this input operation part C72, and a sensor (not shown) for detecting the insertion of the card is installed. Although the input operation part C72 is provided on the table 7C1 in the present embodiment, this is not limited thereto in the present invention, and can be provided as a touch-panel part on the liquid crystal monitor 613.

A medal insertion part 734, a medal insertion detector 735 is placed in the vicinity of the medal insertion part 73A and detects the insertion of the medal.

A medal payout opening C73A from which medals are paid out from a medal collection part 73 provided within the side unit C60, a medal receiving part C73B for receiving the medals which are paid out, and a medal insertion part C74 to which medals are inserted are provided below the table C71 and in front of the side arm C55. A holder, not shown, for attaching a medal storage container C73C is provided in the medal reception part C73B. In addition, a sensor for detecting that a medal is inserted is installed in the medal insertion part C74. The insertion of the medal is detected by this sensor, and the game starts when an instruction signal for game start is transmitted from the sub-control device C90 to the main control device C80, via the input operation part C72, operated by the player. This medal can be paid out according to the betting odds in an event within the game program. For example, predetermined odds are stipulated to the participants of a certain event (win/loss of horse-racing, combat, etc.), much like a book-maker, and the player places a bet on a desired object. Then, medals are paid out according to the odds or the like, based on the win/loss results. The prize resulting from this book-maker is not limited to medals and can be items within the game environment.

In addition, a remaining amount sensor C76 for detecting the remaining amount of the medal collected within the medal collection part C73 is installed in the medal collection part C73. When this remaining amount senor C76 detects that the remaining amount of medals is below a predetermined level, the CPU C91, described hereafter, transmits an empty signal outside. This empty signal can be transmitted to a management system of the game arcade outside of the game machine C1, a mobile terminal held by the staff or the like. In this way, because the staff is notified when the remaining amount of the medals is low, they can be replenished smoothly and the halting of a game due to no remaining medals can be prevented. This remaining amount sensor C76 can be a weight sensor which detects the weight of the medals collected within the medal collection part C73 or whether there is more than a certain amount of medals can be detected by a proximity switch or an infrared sensor. In addition, that there the remaining amount of medals is low can be detected by provided an electrode within the medal collection part C73 in which a weak current can be detected normally, due to the medals touching, and no current is detected when the remaining amount of medals is low.

The liquid crystal display device C61 includes a first support arm C611 which is supported by the side unit C60, a second support arm C612 which is attached to the tip of the first support arm C611, and a flat, rectangular sub-monitor C613 which is attached to the tip of the second support arm C612 and performs liquid crystal display. in addition, the first support arm C611 and the second support arm C612 are drive-controlled by the liquid crystal monitor driving control device C63.

The first support arm C611 can be extended and retracted freely in the direction vertical to the side unit C60. The second support arm C612 can extend and retract freely and can be fixed to an arbitrary angle to the axis direction of the first support arm C611. The liquid crystal monitor C613 can be fixed to an arbitrary angle to the axis direction of the second support arm C612.

The liquid crystal monitor driving control device C63 is controlled by the sub-control device C90. The sub-control device C90 gives instruction to move the liquid crystal monitor C613 to a predetermined position to the liquid crystal monitor driving control device C63, when an instruction signal for the pulling-out of the liquid crystal display device C61 due to the start of a game is received from the main control device C80 The liquid crystal monitor driving control device C63 moves the liquid crystal monitor C613 to the predetermined position when this instruction signal is received. Here, the predetermined position is a position placed facing the player seated in the seat C50, and for example, can be placed at the player's eye level.

A small CCD camera C614 is embedded into the liquid crystal monitor C613. The image taken by the CCD camera C614 is displayed constantly in the liquid crystal display part C61 in the terminal device A30, by operating an input operation part A72 (described hereafter). Because the expressions of the player per se can be viewed during the game in this way, enjoyment increases. In this case, the photographed image can be shown on the entire screen of the liquid crystal monitor C613 or in one section of the screen.

Next, the procedure for pulling out the liquid crystal monitor C613 from the liquid crystal monitor storage part C62 is described, with reference to the FIG. 5C to FIG. 8C.

As shown in FIG. 5C, the liquid crystal monitor C613 is normally stored within the liquid crystal monitor storage part C62 within the side unit C60, with the first support arm C611 and the second support arm C612 is in a retracted state.

Here, when the medal is inserted into the medal insertion part by the player and a game start instruction signal is transmitted from the sub control device C90 to the main control device C80 via the input operation part C72, the main control device C80 transmits an instruction signal for the pull-out of the liquid crystal monitor C613 to the sub-control device C90. The sub-control device C90 transmits an instruction for the movement of the liquid crystal monitor C613 to a predetermined position to the liquid crystal monitor driving control device C63, and as shown in FIG. 6C, the liquid crystal monitor C613 first extends the first support arm C611 and the second support arm C612, and pulls the monitor out so as to slide it upwards from the liquid crystal monitor storage part C62. Subsequently, as shown in FIG. 70, the liquid crystal monitor C613 faces the player by rotating 90° and furthermore, the monitor angle is adjusted by bending the connection part of the liquid crystal monitor C613 and the second support arm C612. Then, as shown in FIG. 8C, the monitor is moved to a position facing the player by bending the connection part of the first support arm C611 and the second support arm C612.

Here, the player can place the liquid crystal monitor C613 in an appropriate position, for example, on the player's eye level, by adjusting the relative angle of the first support arm C611 and the second support arm C612 and the relative angle of the second support arm C612 and the liquid crystal monitor C613. The liquid crystal monitor C613 can be moved to an appropriate position such as this automatically by storing the position in the foregoing membership card or the like.

FIG. 9C is an enlarged perspective view of a section of a traveling part C32.

The traveling part C32 includes four traveling tires C321, a driving control device C322 for rotation-driving these traveling tires C321, a direction control device C323 for controlling the direction of the traveling tires C321, and a rechargeable battery, not shown, for supplying the driving control device C322 and direction control device C323 with power.

The traveling part C32 can move a seat C50 to an arbitrary position on the play area C21 by the driving control device C322 and the direction control device C323. The foregoing rechargeable battery can be recharged through connection to an external power source, but is not limited thereto, and can be recharged by self-induced electromotive force due to a magnetic field, by embedding a magnetic field generating device in the play area C21 and generating a magnetic field by this magnetic field generating device.

In addition, an IC tag detection part C324 for detecting IC tags C211, which are buried in the play area C21, is provided below the tire driving control device C322 of the traveling part C32.

Configurations of the Main Game Machine Body and the Terminal Device

FIG. 10C is a block diagram showing the overall configuration of the game machine C1 and the terminal device C30. In the game machine C1, the main control device A80 of the main game machine body C20 has a wireless communication part C83, and the sub-control device A90 of the terminal device C30 has a wireless communication part C93. These wireless communication parts C89 and C93 can be interconnected via wireless LAN, and in this way, sound data and text data can be communicated and instructions, such as the pulling-out of the liquid crystal monitor C613, can be performed between the main control device C80 and the sub-control device C90.

Configuration of the Main Control Device

FIG. 11C is a block diagram showing the configuration of the main control device C80. The main control device C80 has a CPU C81, a memory C82, a wireless communication part C83, and a database C84, which are connected to a data bus C89.

The wireless communication part C83 includes a transceiving circuit part (RF) C85 for transmitting and receiving signals with the sub-control device C90, and a base band processing part A86 for converting RF (Radio Frequency) signals received by the transceiving circuit part C85 into base band signals and also converting base band signals to be transmitted into RF signals.

The database C84 is a circuit board which includes a memory part to which a game program is stored or a storage medium (for example, a hard disk or ROM cassette) to which the game program is stored. Specifically, a slot to which these circuit boards and storage mediums can be attached and removed is provided in the main control device C80. By attaching and removing these circuit boards and storage mediums from the slot, the game program stored to the database C84 can be replaced, accordingly, and other game programs can be executed. Replacing the game program is not limited to that via hardware, as such, and the game program can be replaced directly by downloading via a communication circuit.

The CPU C81 executes various processing according to the game program.

In other words, the CPU C81 reads the game program stored in the database C84 to the memory C82 and runs the game according to this game program.

Specifically, the CPU C81 receives data including game input data, described hereafter, respectively, from the plurality of terminal devices C30, and generates a single game data according to the game program, based on these data. Then, the CPU C81 generates image data which is shared with all of the terminal devices C30, based on the generated single game data, and outputs this data to the main control device C80.

Here, the single game data includes a plurality of operation character data which can be moved within the single game field generated according to the game program, based on the respective game input data of the plurality of terminal devices C30, and the positional data of this plurality of operation characters.

During the game, the CPU C81 extracts the game program, information expressing the game status corresponding to the time-line in the game field at that time (namely, information expressing events and the like occurring within the game field), and the like from the data base C84, in response to request from the terminal device C30, and transmits these to the terminal device C30, which is the request source, via wireless LAN. In addition, the CPU C81 receives information expressing the operation results of the player from each terminal device C30 and stores this in the memory C82. The CPU C81 runs the game based on the information expressing the operation results of the player stored in the memory C82, and the progression results of the game program is stored in the database C84.

Here, the information expressing the operation results of the player are, for example, selection results by the player from a selection shown to the player via the terminal device C30, based on the progress of the game program, or the results of the operation performed by the player of the character appearing in the game, and is information transmitted from the terminal device C30 as a result of the player operating their respective terminal devices C30. Other players can check the progress status of the current game stored in this database C84 (for example, high-score information, etc.)

Configuration of the Sub-Control Device

FIG. 12C is a block diagram showing the configuration of the sub-control device C90.

The sub-control device C90 has a CPU C91, a memory C92, a wireless communication part C93, an input and output part C94 which is the interface with the speaker C75, and a transmitting part C64 which is the interface with the liquid crystal display device C61, which are connected to a data bus C99.

The wireless communication part C93 includes a transceiving circuit part (RF) C95 for transmitting and receiving signals with the main control device C80, and a base band processing part C96 for converting RF (Radio Frequency) signals received by the transceiving circuit part C95 into base band signals and also converting base band signals to be transmitted into RF signals.

In addition, the sub-control device C90 controls the driving control device C322, the direction control device C323, and the liquid crystal display device C61, based on the input signals from the input operation part C72, the medal insertion part C734, the remaining amount sensor C76, the CCD camera C614, and the IC tag detection part C324.

The CPU C91 executes various operations according to the operation programs stored in the memory C92 and control respective circuit parts and devices according to the operations.

Image data signals generated by in the main control device C80 are output from the liquid crystal monitor C613 through the following procedure.

When the RF signal is received from the main control device C80, the transceiving circuit part C95 supplies this signal to the base band processing part C96 and converts this RF signal to a base band signal. The base band processing part C96 outputs this base band signal to the liquid crystal monitor C613, via the transmitting part C64, Then, this base band signal is output from the liquid crystal monitor C613 as an image.

In addition, sound signals from the main control device C80 are output from the speaker C75 in the same way, by the foregoing procedure, in other words, when the RF signal is received from the main control device C80, the transceiving circuit part C95 converts this RF signal to a base band signal in the base band processing part A96. The base band processing part A96 outputs this base band signal to the speaker A75 as sound, by outputting from the speaker C75 via the input and output part A94.

Furthermore, when the player operates the input operation part C72, after converting various information input by operating the input operation part C72 into packet data, the CPU C91 transmits this to the main control device C80, via the band base processing part C96 and the transceiving circuit part C95. At this time, each terminal device C30 can be identified regardless of the position the terminal devices C30 are placed on the play area C21 by including IP addresses in the packet data. Similarly, the CPU C91 converts positional information read from the IC tag C211 by the IC tag detection part C324 and image information perceived by the CCD camera C614 into packet data and transmits this to the main control device C80.

On the other hand, when an RF signal to which information converted into packet data is superimposed is transmitted from the main control device C80, the CPU C91 receives this RF signal via the transceiving circuit part C95 and the base band processing part C96, displays it in the liquid crystal display monitor C613 and, in addition, controls the driving control device C322 and the direction control device C323 of the traveling part C32.

In other words, when the CPU C91 receives the game program and information expressing the game status corresponding to the time-line in the game field at that time from the main control device C80, the CPU A91 shows various occurrences, such as events, occurring in the game field at this time according to the game program in the liquid crystal display device C61, outputs sound effects from the speaker C75, and moves the main terminal device body C30A, after storing the information, such as the game program, transmitted from the main control device C89 in the memory C82.

In addition, by operating the input operation part C72 while viewing the game content (image, letter information, etc.) shown in the liquid crystal monitor C613, the player using respective terminal device C30 can operate the characters shown in the main display device C22, participate in the progress of the game by operations such as selecting from a selection by letters, and move the terminal device C30 to an designated position on the play area C21.

Game Configuration of the Game Machine

The operations of the game machine C1 are described, with reference to the main flowchart shown in FIG. 13C. In STC1, each player selects a terminal device C30 of their choice from the terminal devices C30 placed on the play area C21 and sits in the seat C50 of the selected terminal device C30. Next, in STC2, each player inserts a medal into a medal insertion opening and presses the start switch in the input operation part C72. Then, in STC3, the locks of the liquid crystal monitor C613 and the seat C50 of the game machine C1 are released and, in STC4, the liquid crystal monitor C613 is pulled out from the liquid crystal monitor storage space C62, moved to the predetermined position, and the seat C50, as well as the position of the liquid crystal monitor C613, is adjusted.

In STC5, the game machine C1 performs a game processing described hereafter. After the game is completed, in STC6, the game machine C1 stores the liquid crystal monitor C613 and also returns the mode of the seat C31 to the normal seat mode.

FIG. 14C is a flowchart of the game processing.

When the game is started in STC11, the game program creates an avatar of the player on STC12. In other words, the game program shows an avatar creating screen in the liquid crystal monitor C613. In this avatar creation screen, the player creates an avatar, which is an alter ego of the player, when participating in the game program. When an image of the players face is taken by the CCD camera C614 and the player enters personal information and the name to be used in the game field to the input operation part C72, the game program creates an avatar based on this information and registers it to the database C84 of the main control device C80.

In STC13, the game program places the terminal device C30 in which the player is seated in the default position on the play area C21. In other words, the game field is divided into a plurality of game fields and each game field has one town. Each game field is an ocean, a forest, or a large city. The play area C21 includes a plurality of sub-areas C212, such as a city area C212A, an ocean area C212B, and a forest area C212C, as stated earlier. These sub-areas 0212 are quasi-spaces corresponding to the environment of the towns in the game environment.

Therefore, the game program sets the town each player is in, in the game field, and moves the terminal device C30 of the player to the sub-area C212, corresponding to the town in which each player is, when the game begins. Or, the terminal device C30 of the player is moved according to the operations of each player of the input operation part C72, and the town in which the player is in the game field is set according to this movement.

In STC14, the game program runs the game according to a unique time-line, generating macroquests in which a plurality of players participate and quests in which only one player participates, and completed the game in STC15.

In this way, the player seated in the terminal device C30 can select whether to view fights between other players or fight himself, with regards to macroquests, by getting involved in macroquests and requesting help from fellow players involved in the macroquest, while communicating various information with the main control device. C80. In addition, if the player is progressing through the game alone, the game progresses by selecting fights while generating quests in which only one player participates.

FIG. 15C is a flowchart of the remaining amount confirmation processing of the game medium.

In STC21, the remaining amount sensor C76 within the medal collection part 073 detects the remaining amount of the medal. This detection can be made by the weight of the medal or the level of the remaining amount of stored medals. When this processing is completed, the process proceeds to STC22.

In STC22, the remaining amount sensor C76 determines whether the remaining amount of medals is lower than a predetermined level, if it is determined that the remaining amount of the medals is higher than the predetermined level, the process returns to the processing in STC 21. In addition, if the remaining amount sensor C76 determined that the remaining amount of the medals is lower than the predetermined level, the process proceeds to the processing in STC23. In STC23, the remaining amount sensor C76 transmits an empty signal.

Other Embodiments

As other embodiments, rather than the game machine B1 being configured by the main game machine B20 and the terminal device B30, it can be configured so that the game can be played by the terminal device alone. In this case, in the configuration of the sub-control device C90 (FIG. 12C), a database for storing the game program and memory are included, as in the main control device C80. Furthermore, the CPU C91 reads the game program stored in the database to the memory, displays image in the liquid crystal monitor C631 according to the game program and runs the game. Then, the liquid crystal monitor C613 can move to the predetermined position and be stored within the side unit C60 by game start signals and game completion signals transmitted by the CPU91.

Although the embodiments of the present invention are described above, the present invention is not limited to the foregoing embodiments and includes modifications, improvements and the like which achieve the objects of the present invention. In addition, the effects described in the embodiments of the present invention are merely a listing of the most preferable effects attained by the present invention, and the effects of the present invention are not limited to the effects described in the embodiments of the present invention.

What is claimed is:

1. A game machine comprising:
a game controller for receiving input from a player;
a monitor for receiving externally or generating internally and showing a game screen, generated according to a game program;
a control for executing the game program;
a seat for seating the player; and
a card reception part for receiving a card for playing a game;
in which said seat part includes a seating detection for detecting that a player is seated and a notification for performing notification when a seated player is not detected and said card is inserted into said card reception part.

2. The game machine according claim 1, wherein:
said card comprises a memory for storing credit data to which subtraction processing is performed when said game program is executed;
wherein said control executes the game program by performing subtraction processing on said credit data read by said card reception part included in said seat part.

3. A game machine comprising:
a main game machine body which comprises a memory part for storing a game program and a main control part for executing said game program stored in said memory part; and
a plurality of terminal devices which comprise an input part and a sub-control part connected to said main game machine body through wireless connection, for transmitting game input data according to input from said input part to said main game machine body;
a display for displaying image based on image data output from said main control
wherein said main control part receives a plurality of game input data from said plurality of terminal devices, generates a single game data corresponding to each terminal device based on the game input data, and generates and outputs to said display part image data which is shared by all terminal devices based on said single game data;
said terminal device comprises a seat for enabling the player to be seated;
said seat part comprises a card reception part to which a card storing individual data of said player is inserted, for reading said individual data, and a seat detection part for detecting that said player is seated;
said card reception part includes a card detection part for detecting that a card is inserted into said card reception part;
said sub-control executes said game program based on the individual data read from said card reception part and/or game input data received by said input; and
said sub-control includes a notification for giving notification when said card detection part detects said card and said seating detection part does not detect seating.

4. The game machine according to claim 3, wherein:
said card comprises a memory for storing credit data to which subtraction processing is performed when the execution of said game program starts;
wherein said sub-control executes said game program by performing subtraction processing on said credit data read by said card reception part.

5. The game machine according to one of claims 3 and 4, wherein:
said sub-control comprises a time measurement for measuring time;
said notification further comprises a lamp part for emitting light,
a sound output part for performing notification by sound, and
a sub-display part for showing image data generated by said sub-control;
wherein, when said seating detection part does not detect seating and said card detection part detects said card, said sub-control transmits a first notification start signal,
said sub-display part shows at least one part of the data read by said card reception part in response to receiving said first notification start signal,
said sound output part outputs at least one part of the data read by said card reception part in response to receiving said first notification start signal,
said time measurement measures the time from said first notification start signal, and
after a predetermined amount of time passes, if said seating detection does not detect seating and said card detection part detects said card, said sub-control transmits a second notification start signal,
said lamp part is illuminated in response to receiving said second notification start signal, and
said sound output part gives second notification by sound in response to receiving said second notification start signal.

6. The game machine according to claim 5, wherein:
said sub-display part comprises a support part, fixed at one end to said seat part and connected at the other end to said sub-display part, for supporting said sub-display part to enable positional changes, and
a fixation driving mechanism for fixing said sub-display part with said support part so as to face the player in a state enabling viewing;
wherein said sub-control transmits a sub-display fixation release signal to said fixation driving mechanism if said card detection part does not detect said card in said card reception part, and
said fixation driving mechanism releases fixation of said sub-display part.

7. The game machine according to claim 6, wherein:
said card reception part further comprises a card holding part for holding said card and a card transfer part for transferring said card to said card holding part;
wherein said time measurement measures the amount of time from said second notification, and
said card transfer part transfers said card to said card holding part, when the time measured by said time measurement reaches a predetermined amount of time and said card detection part detects the card.

8. The game machine according to claim 7, wherein:
said card holding part comprises a holding detection part for detecting that said card transfer part has transferred said card to said card holding part and transmitting a holding completion signal;
wherein said sub-control gives notification through said notification in response to receiving said holding completion signal.

9. The game machine according to claim 5, wherein:
said card reception part further comprises a card holding part for holding said card and a card transfer part for transferring said card to said card holding part;
wherein said time measurement measures the amount of time from said second notification, and
said card transfer part transfers said card to said card holding part, when the time measured by said time measurement reaches a predetermined amount of time and said card detection part detects said card.

10. The game machine according to claim 9, wherein:
said card holding part comprises a holding detection part for detecting that said card transfer part has transferred said card to said card holding part and transmitting a holding completion signal;
wherein said sub-control gives notification through said notification in response to receiving said holding completion signal.

11. A game machine comprising:
a game controller for receiving input from a player;
a display part for receiving externally or generating internally and showing a game image, generated according to a game program;
a seat for seating the player;
a control for executing said game program; and
a lock which has an anti-theft mechanism for hanging or holding the player's belongings, which is normally in an unlocked state and enters a locked state in response to the start of a game.

12. The game machine according to claim 11, wherein:
said lock comprises a U-shaped hook part having an upper aperture and connected to said seat part,
a stopper for closing said upper aperture and preventing the object-to-be-hung hooked to said hook part from being removed,
a lock control part for switch-controlling said upper aperture to both closed and open state by engaging said stopper to said upper aperture or releasing the engagement, and
a load detection part for detecting that said object-to-be-hung is hung on said hook part;
wherein said lock control part changes said upper aperture from an open-state to a closed-state by said stopper, in response to said load detection part detecting that said object-to-be-hung is hung on said hook part and a predetermined excessive load is applied.

13. The game machine according to claim 11, wherein:
said lock comprises a U-shaped hook part having an upper aperture and connected to the seat part,
a stopper for closing said upper aperture and preventing the object-to-be-hung hooked to the hook part from being removed,
a lock control part for switch-controlling said upper aperture to both closed and open state by engaging said stopper to said upper aperture or releasing the engagement;
wherein said game machine comprises a game medium insertion part for inserting a predetermined game medium;
said game medium insertion part includes a game medium insertion detection part for detecting that said predetermined game medium has been inserted;
said seat part includes a seating detection part for detecting that said player is seated; and
said lock control part changes said upper aperture from an open-state to a closed-state by said stopper, in response to said game medium insertion detection part detecting the insertion of said predetermined game medium or said seating detection part detecting that said player is seated.

14. The game machine according to claim 13, wherein:
said seating detection part which transmits a lock release signal when the seating of said player is not detected; and
said lock control part which changes said upper aperture from an open-state to a closed-state by the stopper, in response to receiving said lock release signal.

15. The game machine according to claim 14, comprising:
a time measurement part for measuring time;
wherein said time measurement part measures time in response to the transmission of said lock release signal from said seating detection part, and
said lock control part receives said lock release signal and changes said upper aperture from an open-state to a closed-state by said stopper, in response to the passage of a predetermined amount of time measured by said time measurement part.

16. The game machine according to any one of claims 12 to 15 wherein:
said seat part comprises a seat shell for covering the surrounding area of said seat part,
wherein said hook part is attached to the outside of said seat shell.

17. The game machine according to claim 15 comprising:
a photographing for photographing an image of the object-to-be-hung when said hook part is in a closed-state;
wherein said display part shows the image of the object-to-be-hung taken by said photographing.

18. The game machine according to claim 15, wherein;
said seat part comprises a movement which is provided on the lower part of said seat part, for moving said seat part; and
said control comprises a movement control for driving said movement.

19. The game machine according to claim 16, comprising:
a photographing for photographing an image of said object-to-be-hung when said hook part is in a closed-state;
wherein said display part shows the image of said object-to-be-hung taken by said photographing.

20. The game machine according to claim 16, wherein:
said seat part comprises a movement, which is provided on the lower part of said seat part, for moving said seat part; and
a control comprises a movement control for driving said movement.

21. The game machine according to claim 19, wherein:
said seat part comprises a movement, which is provided on the lower part of said seat part, for moving said seat part; and
a control comprises a movement control for driving said movement.

22. A game machine comprising:
a game controller for receiving input from a player;
a flat display for receiving externally or generating internally and showing a game image, generated according to a game program; and
a seat for seating the player;
wherein said flat display is provided separately from said game machine, is normally stored within a storage part for storing said flat display, and includes a driving mechanism for moving said flat display to a predetermined position and into a state enabling play when the game is started, and on the other hand, automatically stores said flat display into said storage part when the game is completed.

23. A game machine comprising:
a main game machine body comprising a memory for storing a game program,
a control for executing said game program stored in said memory,
an input for receiving input from the player, and
a game medium storage, having a game medium insertion part and a game medium payout part, for storing game media inserted from said game medium insertion part;
a flat display for showing said game image generated by said control according to input from said input; and
a transmitting part for transmitting said game image to said flat display;
wherein said flat display part is provided separately from said main game machine body via a connection device.

24. The game machine according to claim 23, wherein:
a seat for enabling the player to play in a seated state is provided integrally in said main game machine body,
said main game machine body comprises a storage part for storing said flat display part; and
said connection device comprises, at the least, a connection rod of which one end is fixed to said main game machine body and the other end is connected to said flat display;
wherein said connection device moves said flat display part to a predetermined position and into a state enabling play from a state of storage within said storage part during a normal state, with the reception of a game start signal from said control as a trigger, and on the other hand, is connected to a driving mechanism for automatically storing said flat display into said storage part, with the reception of a game completion signal from said control as a trigger.

25. The game machine according to one of claims 23 and 24, wherein:
said game medium storage comprises a level sensor for transmitting an empty signal, in response to detecting that the storage level of said game media stored within said game medium storage is below a predetermined level.

26. A game machine comprising:
a main game machine body comprising a memory for storing a game program, and
a main control for executing said game program stored in said memory;
a main terminal device body comprising an input for receiving input from the player,
a game medium storage, having a game medium insertion part and a game medium payout part, for storing inserted game media, and
a sub-control for transmitting game input data according to input from said input, connected by wireless connection to said main game machine body, to said main control of said main game machine body;
a flat display for showing game image generated by said main control according to input from said input and said game program and
a transmitting part for transmitting said game image to said flat display; and
a main display for showing images based on image data output from said main control;
wherein said main control receives a plurality of game input data from said plurality of terminal devices, generates a single game data according to said game program, based on said plural game input data, generates image data which is shared with all of said terminal devices, based on said generated single game data, and outputs this data to said main display; and
said flat display part is provided separately from said main terminal device body via a connection device.

27. The game machine according to claim 26, wherein:
a game machine comprising;
a seat for enabling the player to play in a seated state is provided integrally in said main game machine body
said main game machine body comprising a storage part for storing said flat display;
a connection device comprising, a connection rod of which one end is fixed to said main terminal device body and the other end is connected to said flat display;
wherein said connection device moves said flat display part to a predetermined position and into a state enabling play from a state of storage within said storage part during a normal state, with the reception of a game start signal from said main control as a trigger, and on the other hand, is connected to a driving mechanism for automatically storing the flat display into said storage part, with the reception of a game completion signal from said main control by said sub-control as a trigger.

28. The game machine according to one of claims 26 and 27, wherein:
said game medium storage comprises a level sensor for transmitting an empty signal, in response to detecting that the storage level of the game media stored within said game medium storage is below a predetermined level.
